(19) United States
(12) Patent Application Publication
(10) Pub. No.: US 2008/0024826 A1
(43) Pub. Date: Jan. 31, 2008

(54) Image processing device and printing apparatus for performing bidirectional printing

(76) Inventors: Toshiaki Kakutani, Shiojiri-shi (JP); Satoshi Yamazaki, Shiojiri-shi (JP); Kazuyoshi Tanase, Shiojiri-shi (JP); Toru Takahashi, Matsumoto-shi (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/881,186

(22) Filed: Jul. 25, 2007

(30) Foreign Application Priority Data
Jul. 27, 2006 (JP) 2006-204143

(51) Int. Cl. G06K 15/00; H04N 1/40

(52) U.S. Cl. 358/3.06; 358/3.03; 358/3.13; 358/502

(57) ABSTRACT

The invention provides a printing method of performing printing on a print medium. The method includes: generating dot data representing a status of dot formation on each of print pixels of a print image to be formed on the print medium, by performing a halftone process on image data representing a input tone value of each of pixels constituting an original image; generating the print image by combining forward pass dots with backward pass dots in a common printing area in such a manner that each main scan line includes both the forward pass dots and the backward pass dots, the forward pass dots being formed on a plurality of pixels of a first pixel group in a forward pass of main scan of a print head, the backward pass dots being formed on a plurality of pixels of a second pixel group in a backward pass of main scan of the print head. The generating dot data includes setting a halftone process condition for reducing a deterioration of image quality due to a positional misalignment between the forward pass dots formed in the first pixel group and the backward pass dots formed in the second pixel group.

### BACKGROUND

1. Technical Field

The present invention relates to a technique of forming dots on a print medium to generate a print image.

2. Related Art

Inkjet printers have been used widely as the output device of computers. Various techniques, for example, the improved error diffusion or another halftone technique and the adequate formation control of ink dots (adjustment of the dot formation order) have been proposed for the inkjet printers to improve the image quality as disclosed in JP-A-2002-11859.

However, the improved image quality by the halftone process and the improved image quality by the adequate formation control of ink dots have been studied and discussed as individually different technical issues in the art. There has been no approach of organically combining these two image quality-improving techniques to attain the synergistic effects on improvement of image quality.

### SUMMARY

An advantage of some aspect of the invention is to provide a technique that organically combines the halftone process with the formation control of ink dots to further improve the image quality.

The invention provides a printing method of performing printing on a print medium. The method includes: generating dot data representing a status of dot formation on each of print pixels of a print image to be formed on the print medium, by performing a halftone process on image data representing a input tone value of each of pixels constituting an original image; generating the print image by combining forward pass dots with backward pass dots in a common printing area in such a manner that each main scan line includes both the forward pass dots and the backward pass dots, the forward pass dots being formed on a plurality of pixels of a first pixel group in a forward pass of main scan of a print head, the backward pass dots being formed on a plurality of pixels of a second pixel group in a backward pass of main scan of the print head. The generating dot data includes setting a halftone process condition for reducing a deterioration of image quality due to a positional misalignment between the forward pass dots formed in the first pixel group and the backward pass dots formed in the second pixel group.

In the printing method of the invention, the condition of the halftone process is set to reduce the potential deterioration of the image quality due to the positional misalignment between the forward pass dots formed in the forward pass of the print head and the backward pass dots formed in the backward pass of the print head. Each main scan line consists of both the forward pass dots and the backward pass dots. This arrangement effectively reduces the graininess, the uneven color, and the banding and thereby totally improves the image quality.

The technique of setting the condition of the halftone process is not restrictively applied to a typical halftone process using a dither matrix but is also applicable to another halftone process adopting the error diffusion method. The halftone process may, for example, perform error diffusion for each of multiple different pixel position groups.

One applicable procedure individually performs error diffusion in each of multiple different pixel position groups, in addition to the general overall error diffusion. Another applicable procedure increases the weight to be applied to a diffused error in each of pixels included in plural different pixel position groups. The inherent features of the error diffusion technique enable all dot patterns formed in print pixels included in the respective pixel position groups to have specific characteristics at each tone value.

In one aspect of the printing apparatus of the invention, the printing structure is set to have a greater consecutive number of either the forward pass dots or the backward pass dots in a sub-scanning direction than a consecutive number of the corresponding dots in a main scanning direction. As confirmed by the inventors' experiments, this arrangement enhances the banding prevention effect.

In the printing apparatus of the invention, the printing structure may form each sub-scan line by only either one of the forward pass dots and the backward pass dots.

In another aspect of the printing apparatus of the invention, the printing structure performs sub-scan feed by a fixed sub-scan feed volume of WP×(N+½), where WP represents a length of each print pixel in a sub-scanning direction and N denotes a non-negative integral value. This arrangement adopts the sub-scan of regular feed having substantially no error of the sub-scan feed volume to form each main scan line by the bidirectional main scan.

In still another aspect of the printing apparatus of the invention, both the dots formed in the first pixel group and the dots formed in the second pixel group have either blue noise characteristics or green noise characteristics. The ‘blue noise characteristics’ and the ‘green noise characteristics’ in the specification hereof are defined by the cited reference ‘Digital Halftoning’ (written by Robert Ulichney).

The technique of the invention is not restricted to the printing apparatus described above but is attained by various other applications including a corresponding printing method, a method of producing printed matter, computer programs causing the computer to attain the functions of the printing apparatus and these methods, recording media with such computer programs recorded therein.

### BRIEF DESCRIPTION OF THE DRAWINGS

FIG. 1 is an explanatory drawing showing the summary of a printing system as the printing apparatus of this embodiment;

FIG. 2 is an explanatory drawing showing the constitution of a computer as the image processing device of this embodiment;

FIG. 3 is an explanatory drawing showing the schematic structure of the color printer of this embodiment;

FIG. 4 is an explanatory drawing showing an array of inkjet nozzles for an ink spray head;

FIG. 5 shows a dot recording mode in a comparative example;

FIG. 6 shows a dot recording mode in a first embodiment of the invention;

FIG. 7 shows a dot recording mode in a second embodiment of the invention;

FIG. 8 shows a dot recording mode in a third embodiment of the invention;

FIG. 9 shows a dot recording mode in a fourth embodiment of the invention;

FIG. 10 shows a dot recording mode in a fifth embodiment of the invention;

FIG. 11 is a flow chart showing the flow of the image printing process of this embodiment;

FIG. 12 is an explanatory drawing conceptually showing an LUT referenced for color conversion processing;

FIG. 13 is an explanatory drawing conceptually showing an example of part of a dither matrix;

FIG. 14 is an explanatory drawing conceptually showing the state of deciding the presence or absence of dot formation for each pixel while referencing the dither matrix;

FIG. 15 is an explanatory drawing showing the findings that became the beginning of the invention of this application;

FIG. 16 is an explanatory drawing conceptually showing an example the spatial frequency characteristics of threshold values set for each pixel of the dither matrix having blue noise characteristics;

FIGS. 17A to 17C are explanatory drawings conceptually showing the sensitivity characteristics VTF for the spatial frequency of the visual sense that humans have;

FIGS. 18A to 18C are explanatory drawings showing the results of studying the granularity index of forward scan images for various dither matrixes having blue noise characteristics;

FIGS. 19A and 19B are explanatory drawings showing the results of studying the correlation coefficient between the position misalignment image granularity index and the forward scan image granularity index;

FIG. 20 is an explanatory drawing showing the principle of it being possible to suppress the image quality degradation even when dot position misalignment occurs during bidirectional printing;

FIG. 21 is an explanatory drawing showing the degradation of image quality due to presence or absence of dot position misalignment with images formed using a general dither matrix;

FIG. 22 is a flow chart showing the flow of the process of generating a dither matrix referenced with the tone number conversion process of this embodiment.

### DESCRIPTION OF EXEMPLANARY EMBODIMENT

The present invention is explained in the following sequence based on embodiments.

### A. Summary of the Embodiment:

### B. Device Constitution:

### C. Summary of the Image Printing Process:

D. Principle of Suppressing Degradation of Image Quality Due to Dot Position misalignment:

### E. Dither Matrix Generating Method:

### F. Variation Examples:

### A. Summary of the Embodiments

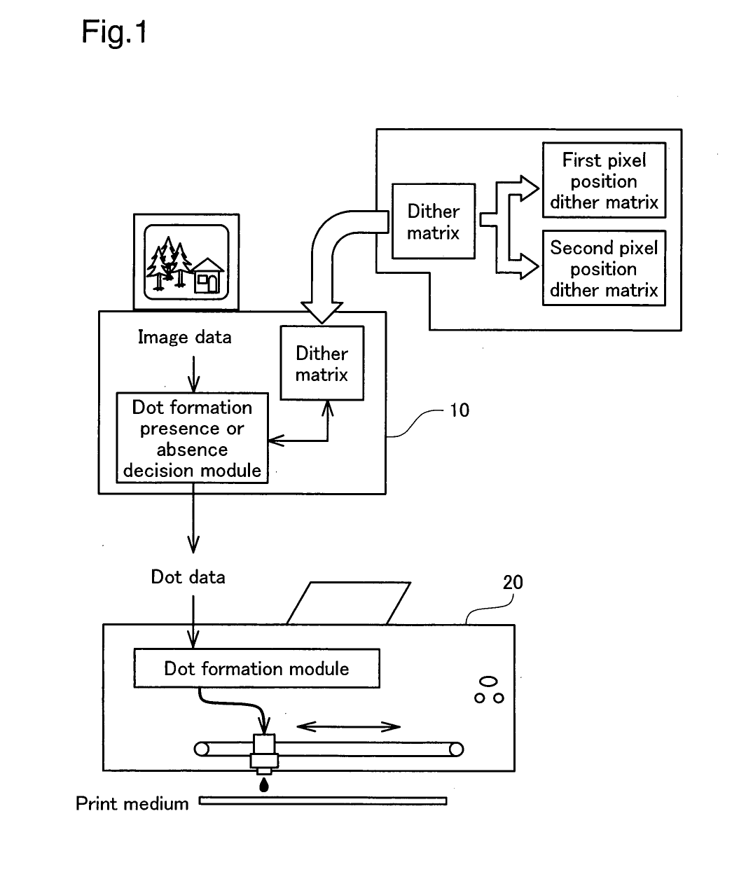

Before starting the detailed description of the embodiment, a summary of the embodiment is described while referring to FIG. 1. FIG. 1 is an explanatory drawing showing a summary of a printing system as the printing apparatus of this embodiment. As shown in the drawing, the printing system consists of a computer 10 as the image processing device, a printer 20 that prints the actual images under the control of the computer 10 and the like, and entire system is unified as one and functions as a printing apparatus.

A dot formation presence or absence decision module and a dither matrix are provided in the computer 10, and when the dot formation presence or absence decision module receives image data of the image to be printed, while referencing the dither matrix, data (dot data) is generated that represents the presence or absence of dot formation for each pixel, and the obtained dot data is output toward the printer 20.

A dot formation head 21 that forms dots while moving back and forth over the print medium and a dot formation module that controls the dot formation at the dot formation head 21 are provided in the printer 20. When the dot formation module receives dot data output from the computer 10, dot data is supplied to the head to match the movement of the dot formation head 21 moving back and forth. As a result, the dot formation head 21 that moves back and forth over the print medium is driven at a suitable timing, forms dots at suitable positions on the print medium, and an image is printed.

Also, with the printing apparatus of this embodiment, by performing so called bidirectional printing for which dots are formed not only during forward scan of the dot formation head 21 but also during backward scan, it is possible to rapidly print images. It makes sense that when performing bidirectional printing, when dot formation position misalignment occurs between dots formed during forward scan and dots formed during backward scan, the image quality is degraded. In light of this, it is normal to have built into this kind of printer a special mechanism or control for adjusting at a high precision the timing of dot formation of one of the back and forth movements to the other timing, and this is one factor in causing printers to be larger or more complex.

Considering this kind of point, with the printing apparatus of this embodiment shown in FIG. 1, as the dither matrix referenced when generating dot data from the image data, a matrix having at least the following two characteristics is used. Specifically, as the first characteristic, this is a matrix for which it is possible to classify the dither matrix pixel positions into a first pixel position group and a second pixel position group. Here, the first pixel position and the second pixel position are pixel positions having a relationship whereby when one has dots formed at either the forward scan or the backward scan, the other has dots formed at the opposite. Then as the second characteristic, this is a matrix for which the dither matrix, a matrix for which the threshold values set for the first pixel positions are removed from the dither matrix (first pixel position matrix), and a matrix for which the threshold values set for the second pixel positions are removed (second pixel position matrix) all have blue noise characteristics. The first pixel position group and the second pixel position group of this embodiment are equivalent to the ‘first pixel position group’ and the ‘second pixel position group’ in the claims of the invention.

Here, though the details are described later, the inventors of this application discovered the following kind of new findings. Specifically, there is a very strong correlation between the image quality of images for which the dot formation position was displaced between the forward scan and the backward scan and the image quality of images made only by dots formed during forward scan (images obtained with only the dots formed during the backward scan removed from the original image; hereafter called “forward scan images”), or the image quality of images made only by dots formed during backward scan (images obtained with only the dots formed during the forward scan removed from the original image; hereafter called “backward scan images”). Then, if the image quality of the forward scan images or the image quality of the backward scan images is improved, even when dot formation position misalignment occurs between the forward scan and the backward scan of bidirectional printing, it is possible to suppress degradation of image quality. Therefore, the dither matrix can be classified by the characteristics noted above, specifically, it is possible to classify as a first pixel position matrix and a second pixel position matrix, and if dot data is generated using a dither matrix such as one for which these three matrixes have blue noise characteristics, it is possible to have both the forward scan images and the backward images be good image quality images, so it is possible to suppress to a minimum the degradation of image quality even when there is dot formation position misalignment during bidirectional printing. As a result, when adjusting the dot formation timing of one of the back and forth movements to the other timing, there is no demand for high precision, so it is possible to have a simple mechanism and control for adjustment, and thus, it is possible to avoid the printer becoming large and complex. Following, this kind of embodiment is described in detail.

### B. Device Constitution

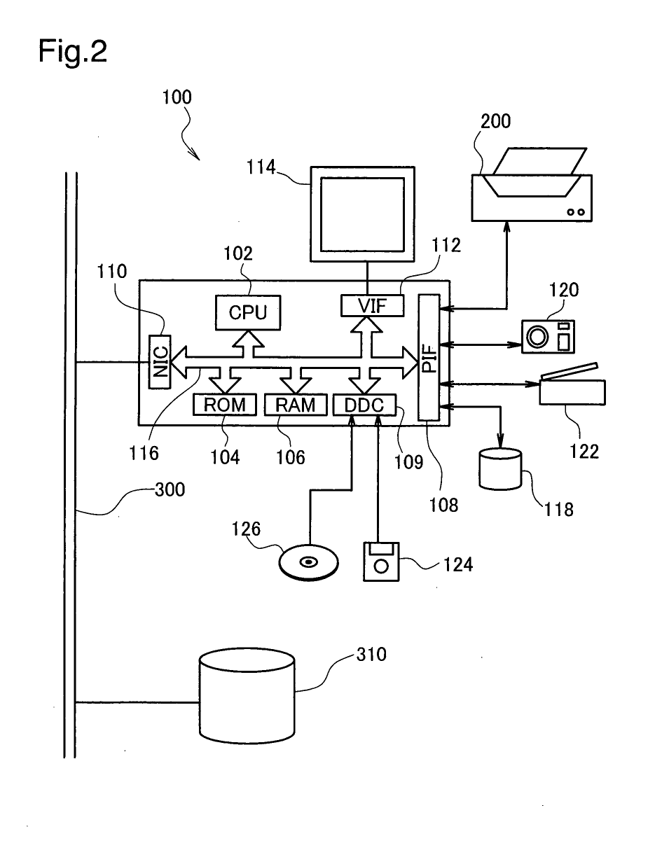

FIG. 2 is an explanatory drawing showing the constitution of the computer 100 as the image processing device of this embodiment. The computer 100 is a known computer constituted by a CPU 102 as the core, a ROM 104, a RAM 106 and the like being mutually connected by a bus 116.

Connected to the computer 100 are a disk controller DDC 109 for reading data of a flexible disk 124, a compact disk 126 or the like, a peripheral device interface PIF 108 for performing transmission of data with peripheral devices, a video interface VIF 112 for driving a CRT 113, and the like. Connected to the PIF 108 are a color printer 200 described later, a hard disk 118, or the like. Also, if a digital camera 120 or color scanner 122 or the like is connected to the PIF 108, it is possible to perform image processing on images taken by the digital camera 120 or the color scanner 122. Also, if a network interface card NIC 110 is mounted, the computer 100 is connected to the communication line 300, and it is possible to fetch data stored in the storage device 310 connected to the communication line. When the computer 100 fetches image data of the image to be printed, by performing the specified image processing described later, the image data is converted to data representing the presence or absence of dot formation for each pixel (dot data), and output to the color printer 200.

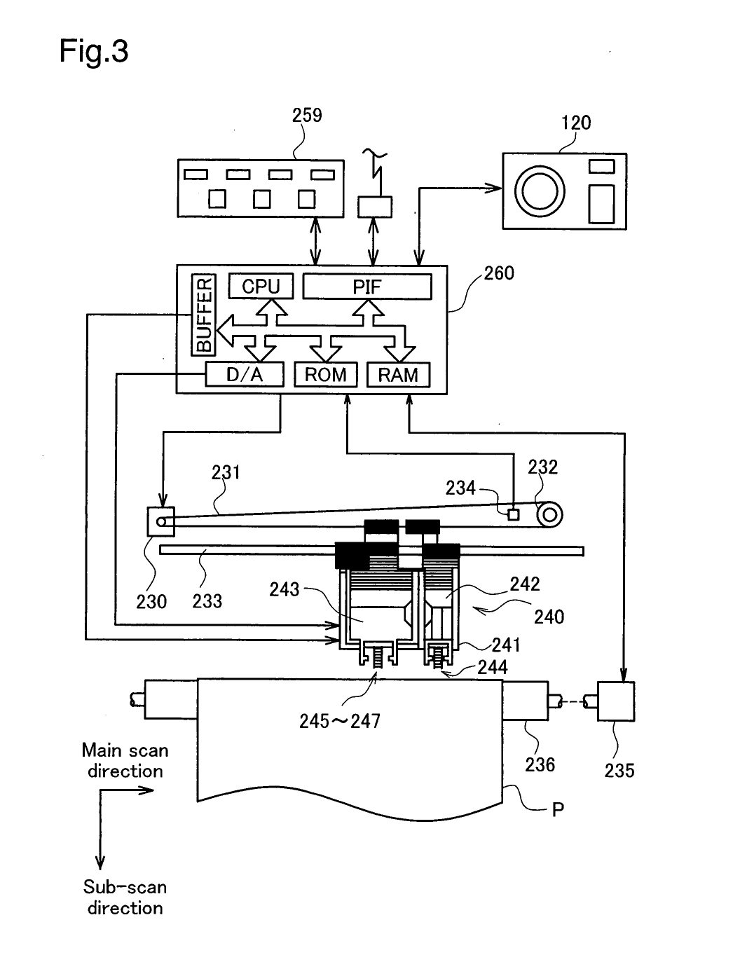

FIG. 3 is an explanatory drawing showing the schematic structure of the color printer 200 of this embodiment. The color printer 200 is an ink jet printer capable of forming dots of four colors of ink including cyan, magenta, yellow, and black. Of course, in addition to these four colors of ink, it is also possible to use an inkjet printer capable of forming ink dots of a total of six colors including an ink with a low dye or pigment concentration of cyan (light cyan) and an ink with a low dye or pigment concentration of magenta (light magenta). Note that following, in some cases, cyan ink, magenta ink, yellow ink, black ink, light cyan ink, and light magenta ink are respectively called C ink, M ink, Y ink, K ink, LC ink, and LM ink.

As shown in the drawing, the color printer 200 consists of a mechanism that drives a printing head 241 built into a carriage 240 and performs blowing of ink and dot formation, a mechanism that moves this carriage 240 back and forth in the axial direction of a platen 236 by a carriage motor 230, a mechanism that transports printing paper P by a paper feed motor 235, a control circuit 260 that controls the dot formation, the movement of the carriage 240 and the transport of the printing paper, and the like.

Mounted on the carriage 240 are an ink cartridge 242 that holds K ink, and an ink cartridge 243 that holds each type of ink C ink, M ink, and Y ink. When the ink cartridges 242 and 243 are mounted on the carriage 240, each ink within the cartridge passes through an introduction tube that is not illustrated and is supplied to each color ink spray heads 244 to 247 provided on the bottom surface of the printing head 241.

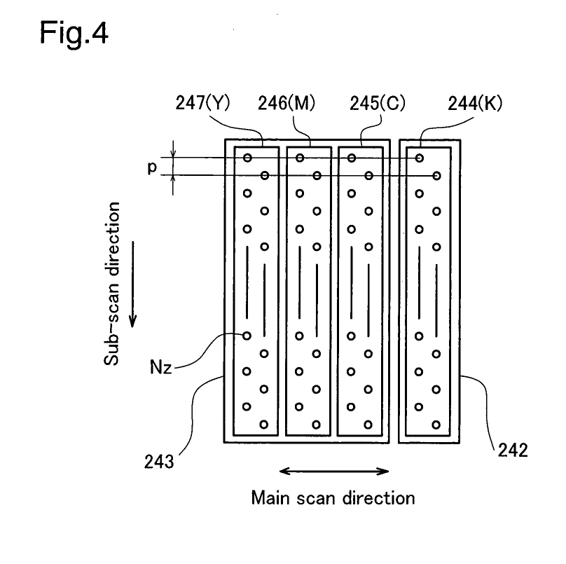

FIG. 4 is an explanatory drawing showing an array of inkjet nozzle Nz for the ink spray heads 244 to 247. As shown in the drawing, on the bottom surface of the ink spray heads are formed four sets of nozzle arrays that spray each color of ink C, M, Y, and K, and 48 nozzles Nz per one set of nozzle arrays are arranged at a fixed nozzle pitch k.

The control circuit 260 of the color printer 200 is constituted by a CPU, ROM, RAM, PIF (peripheral device interface), and the like mutually connected by a bus, and by controlling the operation of the carriage motor 230 and the paper feed motor 235, it controls the main scan movement and Sub-scan movement of the carriage 240. Also, when the dot data output from the computer 100 is received, by supplying dot data to the ink spray heads 244 to 247 to match the main scan or Sub-scan movement of the carriage 240, it is possible to drive these heads.

The color printer 200 having the kind of hardware constitution noted above, by driving the carriage motor 230, moves each color ink spray head 244 to 247 back and forth in the main scan direction, and by driving the paper feed motor 235, moves the printing paper P in the Sub-scan direction. The control circuit 260, by driving the nozzles at a suitable timing based on dot data to match the back and forth movement of the carriage 240 (main scan) and the paper feed movement of the print medium (Sub-scan), forms suitable colored ink dots at suitable positions on the print medium. By working in this way, the color printer 200 is able to print color images on the printing paper.

Note that though the printer of this embodiment was described as a so called inkjet printer that forms ink dots by spraying ink drops toward a print medium, it can also be a printer that forms dots using any method. For example, the invention of this application, instead of spraying ink drops, can also be suitably applied to a printer that forms dots by adhering each color of toner powder onto the print medium using static electricity, or a so called dot impact method printer.

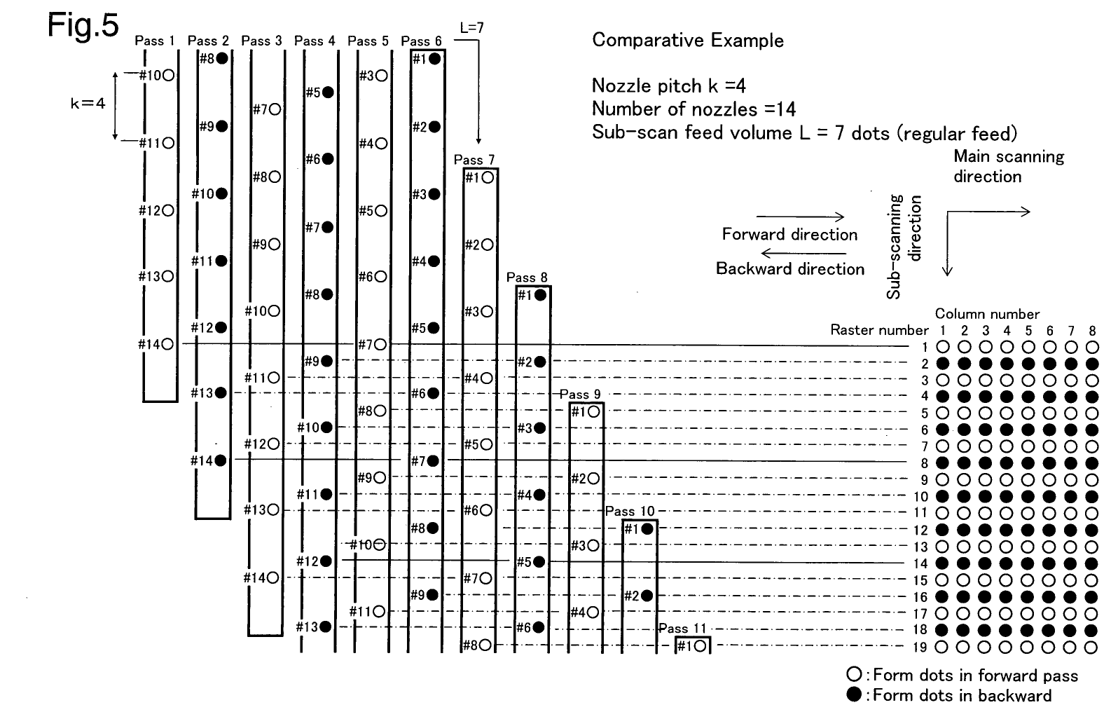

FIG. 5 shows a dot recording mode in a comparative example. The dot recording mode of this comparative example adopts bidirectional printing with the number of nozzles N=14 and the sub-scan feed volume L=7 dots (=7×dot pitch k). In this recording mode, the printing head 241 performs main scan in the forward direction in odd passes, while performing main scan in the backward direction in even passes. Namely forward pass dots (expressed by open circles ‘◯’) are formed in the odd passes by the main scan in the forward direction, and backward pass dots (expressed by closed circles ‘’) are formed in the even passes by the main scan in the backward direction. In this recording mode, each main scan line (line as a set of dots aligned in the main scanning direction) is formed by only the main scan in one single direction. For example, a main scan line with a raster number 1 is formed by only the main scan in the forward direction, and a main scan line with a raster number 2 is formed by only the main scan in the backward direction.

In this recording mode, when there is a positional misalignment between the dot formation positions by the main scan in the forward direction and the dot formation positions by the main scan in the backward direction, the dots are simply shifted in the main scanning direction in the unit of each main scan line. Such shifting has no substantial effect on the dot overlap status. For example, even when the main scan line with the raster number 1 is shifted in the forward direction of the main scan and the main scan line with the raster number 2 is shifted in the backward direction of the main scan in the example of FIG. 5, these two main scan lines do not mutually approach to overlap or are not away from each other. Namely there is no substantial effect on the dot overlap status.

In this recording mode, however, a misalignment of the dot formation positions in the sub-scanning direction often leads to deterioration of the image quality. Such deterioration of the image quality includes the banding as the streak-shaped noise due to the error of the sub-scan feed volume and the uneven color due to the vibration of the printing head 241 in the sub-scanning direction during the main scan.

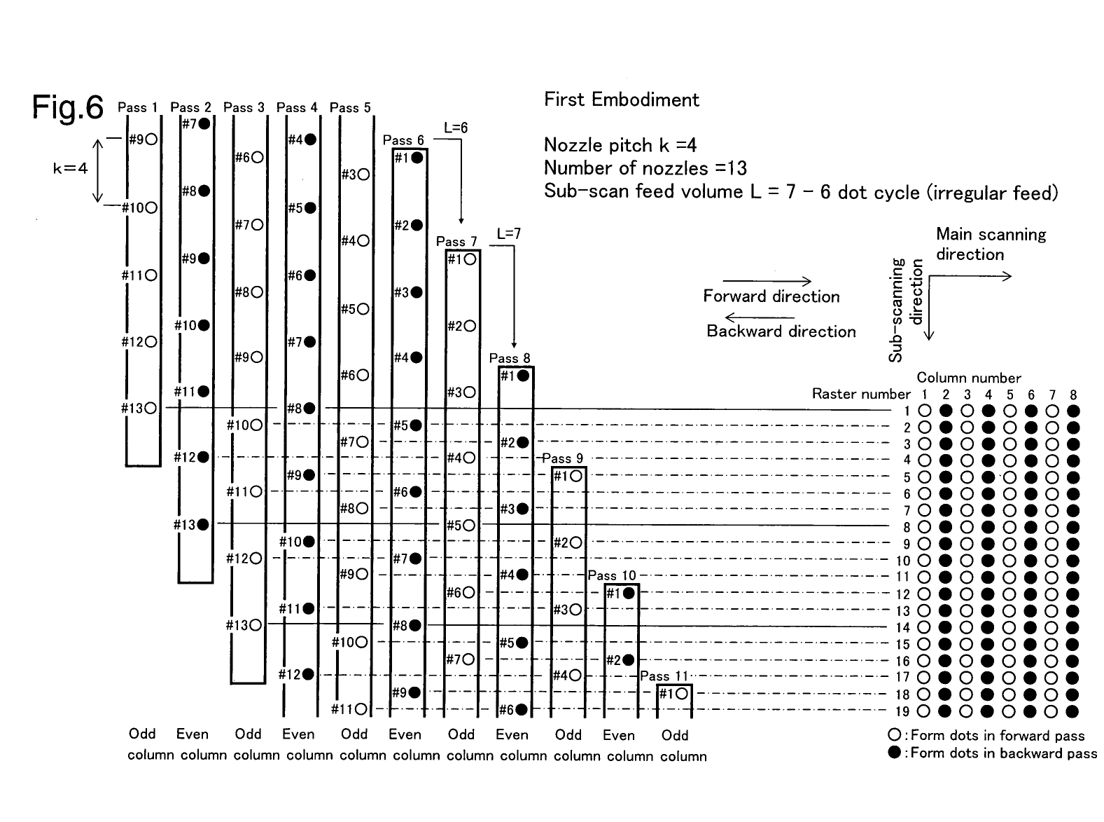

FIG. 6 shows a dot recording mode in a first embodiment of the invention. The dot recording mode of the first embodiment adopts bidirectional printing with the number of nozzles N=13 and the alternate repetition of the sub-scan feed volume L=7 dots and L=6 dots, that is, the irregular sub-scan feed of 7 dots and 6 dots. In this recording mode, each main scan line is formed by the bidirectional main scan. Namely each main scan line consists of both the forward pass dots ‘◯’ and the backward pass dots ‘’. In pass 1, pass 3, and subsequent odd passes, dots are formed in odd columns. In pass 2, pass 4, and subsequent even passes, dots are formed in even columns.

The dot recording mode of the first embodiment has the opposite characteristics to those of the conventional dot recording mode of the comparative example. Namely this dot recording mode has a high potential for deterioration of the image quality due to a misalignment of the dot formation positions in the main scanning direction, especially the graininess recognized as the roughness of an image. On the contrary, this dot recording mode has a low potential for deterioration of the image quality, such as the banding and the uneven color due to the vibration of the printing head 241 in the sub-scanning direction. The misalignment of the dot formation positions in the main scanning direction is conventionally the predominant cause of the deteriorating image quality. As the technical common knowledge in the art, the conventional dot recording mode of the comparative example has the significant advantage in reduction of the graininess especially in bidirectional printing. For the best image quality, it is essential to combine the conventional dot recording mode of the comparative example with the expensive, high-performance hardware, which adopts the measures to overcome the drawbacks of the conventional dot recording mode and attains the high accuracy of sub-scan feed in the sub-scanning direction and the reduced vibration of the printing head in the sub-scanning direction. This combined application, however, still asks for the user's tolerance for some level of poor image quality by the uneven color and the banding.

The inventors of the present invention have developed a halftone process (described later) that effectively prevents potential deterioration of the image quality, for example, the graininess due to a misalignment of the dot formation positions in the main scanning direction and the uneven color due to the vibration of the printing head 241 in the subs-canning direction. The inventors have gone beyond the boundary of the technical common knowledge and made experiments and analyses on the combination of this halftone process with the dot recording mode. According to the results of the experiments and the analyses, the inventors have found that adoption of the halftone process hardly causes the graininess even in the presence of a positional misalignment in the main scanning direction between the dot formation positions in the forward pass of the main scan and the dot formation positions in the backward pass of the main scan. This graininess reduction effect of the halftone process is similarly found in the combination with the dot recording mode of the first embodiment, as well as in the combination with the conventional dot recording mode of the comparative example shown in FIG. 5. Based on these findings, the inventors have proved that the combination of the dot recording mode of the first embodiment having the effects of preventing the banding and the uneven color with the halftone process (described later) having the graininess reduction effect attains the best image quality with regard to all the graininess, the uneven color, and the banding.

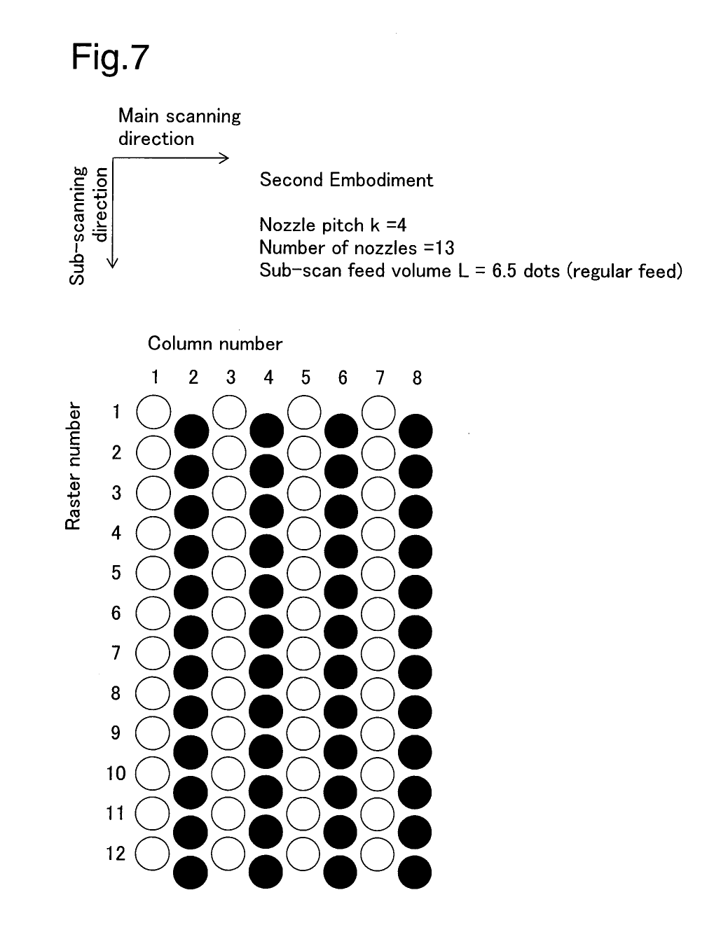

FIG. 7 shows a dot recording mode in a second embodiment of the invention. The dot recording mode of the second embodiment adopts bidirectional printing of regular sub-scan feed with the number of nozzles N=13 and the sub-scan feed volume L=6.5 dots (fixed value). The differences of this dot recording mode from the dot recording mode of the first embodiment are that the dot formation positions in even columns are shifted by a pitch of half pixel in the sub-scanning direction from the dot formation positions in odd columns and that the sub-scan feed volume L is fixed to 6.5 dots. This dot recording mode adopts the sub-scan of regular feed having substantially no error of the sub-scan feed volume to form each main scan line by the bidirectional main scan.

In both the dot recording modes of the first embodiment and the second embodiment, each sub-scan line (line as a set of dots aligned in the sub-scanning direction or a set of dots in each column) is formed by only the main scan in one single direction, that is, either in the forward direction or in the backward direction. For example, in the dot recording modes of the first embodiment and the second embodiment, a first column has only the forward pass dots, while a second column has only the backward pass dots.

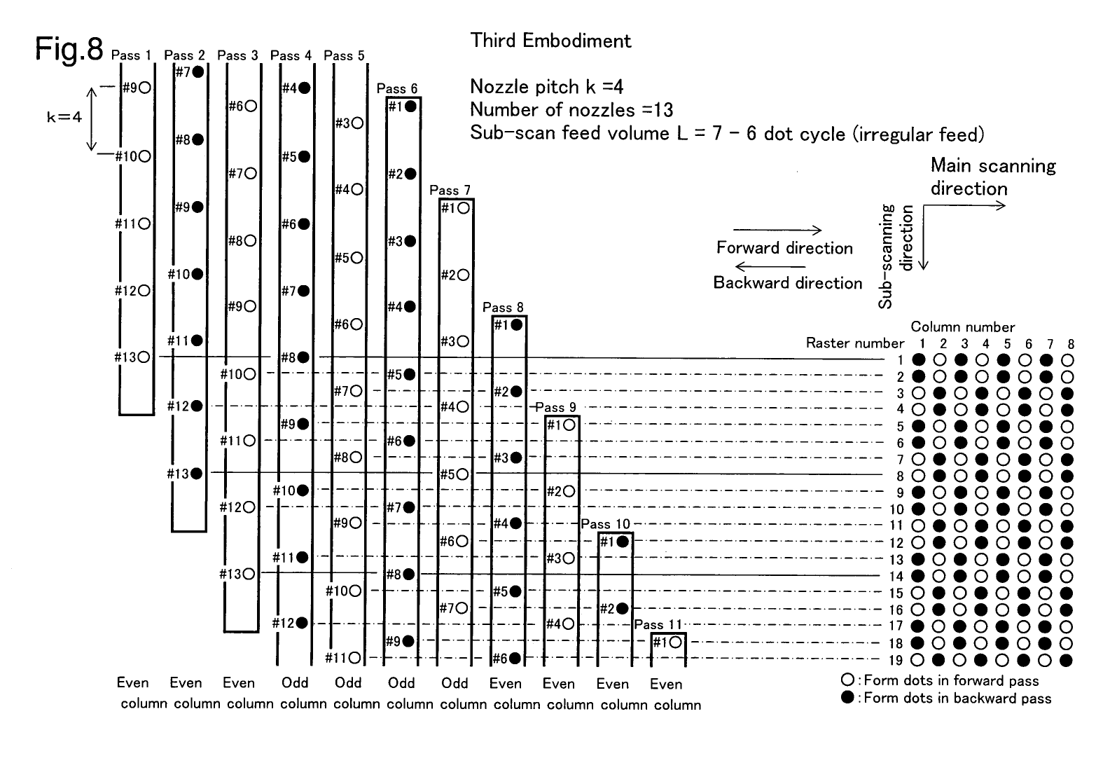

FIG. 8 shows a dot recording mode in a third embodiment of the invention. The dot recording mode of the third embodiment adopts bidirectional printing with the number of nozzles N=13 and the alternate repetition of the sub-scan feed volume L=7 dots and L=6 dots, that is, the irregular sub-scan feed of 7 dots and 6 dots. These conditions are common to those in the dot recording mode of the first embodiment. The dot recording mode of the third embodiment forms dots on even columns in passes 1 through 3 and in pass 8, while forming dots on odd columns in passes 4 through 7. These eight passes are periodically repeated to form each main scan line by the bidirectional main scan.

Unlike the dot recording modes of the first embodiment and the second embodiment, the dot recording mode of the third embodiment forms each sub-scan line by both the forward pass dots and the backward pass dots. This dot recording mode has been proved to attain the high image quality by combination with the halftone process (described later). The dot recording technique of forming each main scan line by the bidirectional main scan can attain the high image quality by combination with the halftone process (described later). It is preferable to set a greater consecutive number of either the forward pass dots or the backward pass dots in the sub-scanning direction than a consecutive number of the corresponding dots in the main scanning direction. Such setting further enhances the banding prevention effect as confirmed by the inventors' experiments. In the illustrated example, the consecutive number of either the forward pass dots or the backward pass dots is ‘2’ in the sub-scanning direction and is ‘1’ in the main scanning direction.

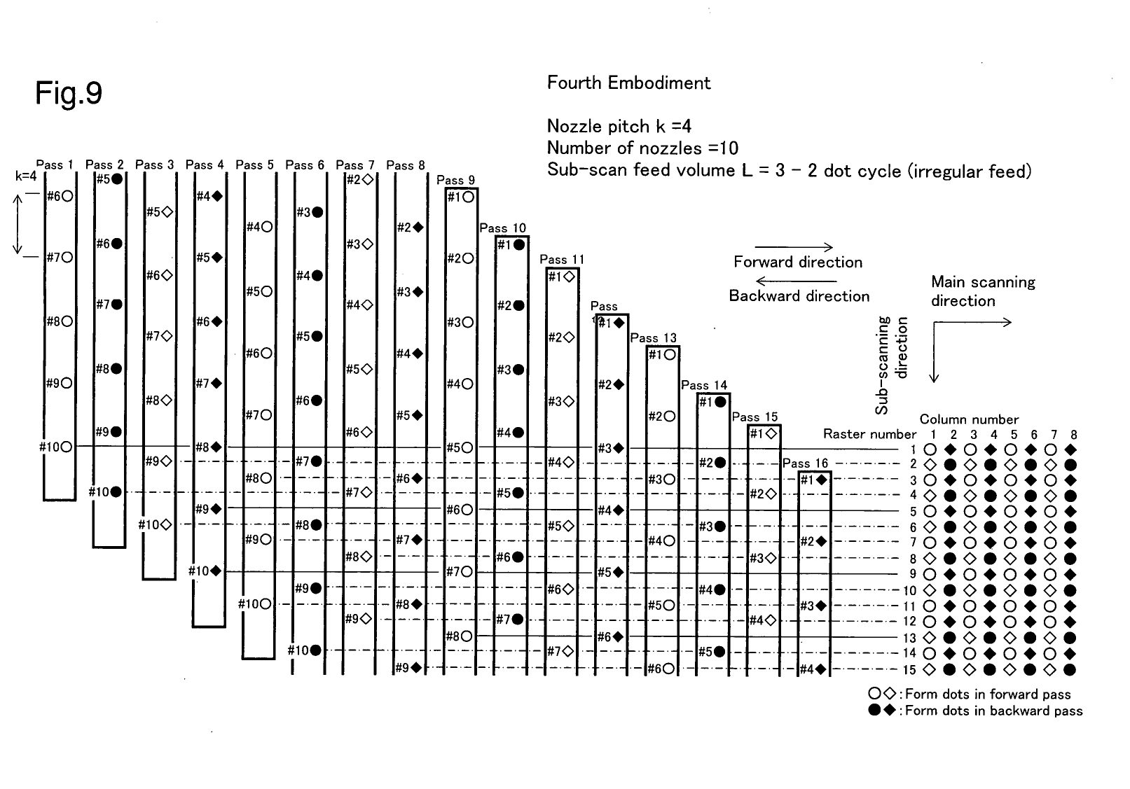

FIG. 9 shows a dot recording mode in a fourth embodiment of the invention. The dot recording mode of the fourth embodiment adopts bidirectional printing with the number of nozzles N=10 and the alternate repetition of the sub-scan feed volume L=3 dots and L=2 dots, that is, the irregular sub-scan feed of 3 dots and 2 dots. In this dot recording mode, dot are formed at the positions of column numbers ‘1+4N’, ‘2+4N’, ‘3+4N’, ‘4+4N’, ‘1+4N’, ‘4+4N’, ‘1+4N’, ‘2+4N’, ‘3+4N’, ‘4+4N’, ‘1+4N’, ‘2+4N’, ‘3+4N’, ‘2+4N’, ‘3+4N’, ‘4+4N’ in passes 1 through 16. Here N denotes a non-negative integral value. The dots are recorded by repetition of these 16 passes.

In this dot recording mode, each main scan line is formed by four passes including both the forward pass and the backward pass. This dot recording mode has been proved to attain the high image quality by combination with the halftone process (described later). Namely the dot recording mode of forming each main scan line by four passes ensures the high image quality by combination with the halftone process (described later).

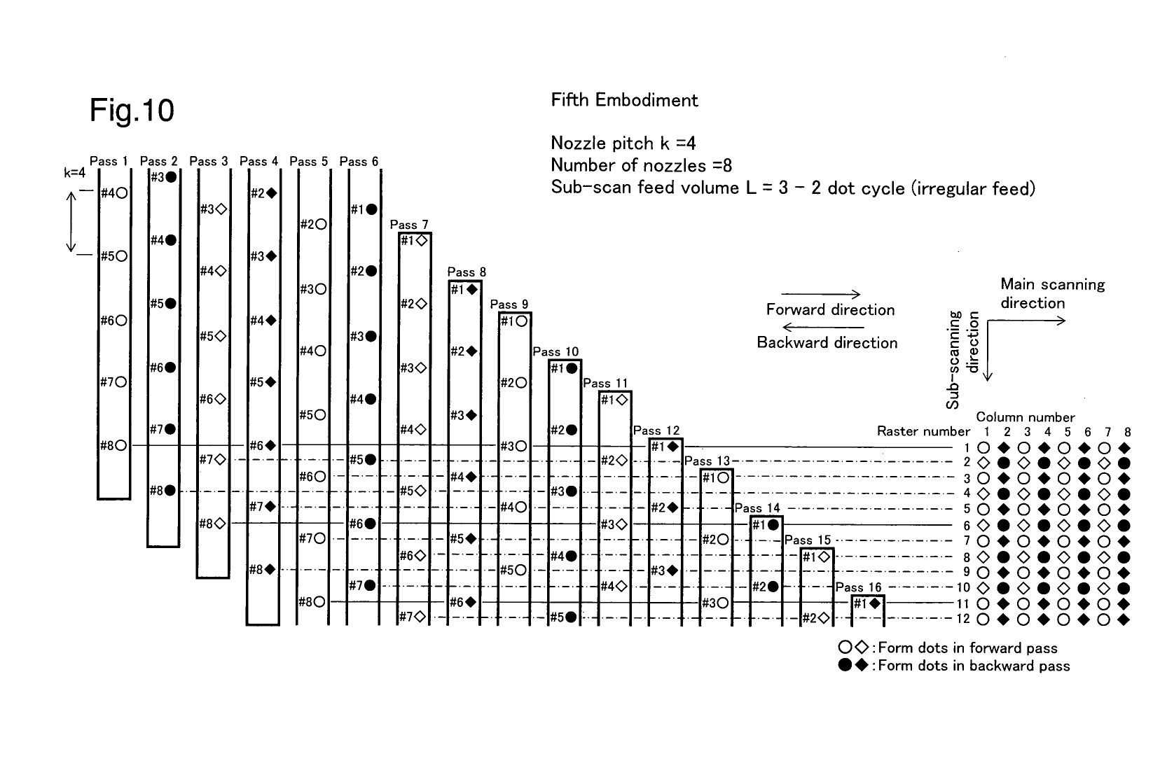

FIG. 10 shows a dot recording mode in a fifth embodiment of the invention. The dot recording mode of the fifth embodiment is similar to the dot recording mode of the fourth embodiment shown in FIG. 9 with the number of nozzles N decreased from 10 to 8. The primary difference from the dot recording modes of the above embodiments is varying numbers of passes for dot formation on respective main scan lines. For example, main scan lines having raster numbers ‘1+5×N’ (N denotes a non-negative integral value) are formed by four passes, while the other main scan lines are formed by three passes. In the illustrated example, a main scan line having a raster number ‘1’ is completed by forming dots at the pixel positions of odd column numbers alternately in pass 1 and pass 9 and forming dots at the pixel positions of even column numbers alternately in pass 4 and pass 12. Another main scan line having a raster number ‘2’ is completed, on the other hand, by forming dots at the pixel positions of odd column numbers alternately in pass 3 and pass 11 and forming dots at the pixel positions of even column numbers in only pass 5.

In this dot recording mode, each main scan line is formed by four passes or three passes including both the forward pass and the backward pass. This dot recording mode has been proved to attain the high image quality by combination with the halftone process (described later). Namely the dot recording mode of forming each main scan line by the varying number of passes ensures the high image quality by combination with the halftone process (described later).

### C. Summary of the Image Printing Process

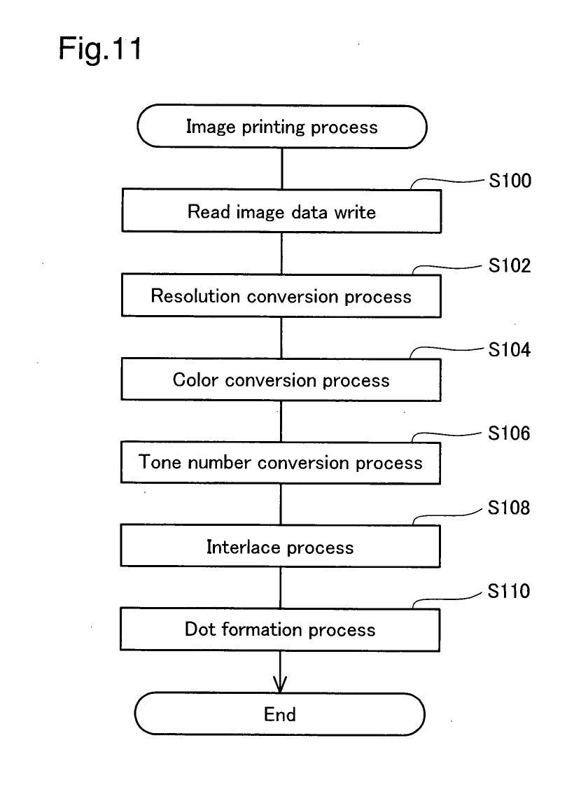

FIG. 11 is a flow chart showing the process flow of adding a specified image process by the computer 100 to an image to be printed, converting image data to dot data expressed by the presence or absence of dot formation, supplying to the color printer 200 as control data the obtained dot data, and printing the image.

When the computer 100 starts image processing, first, it starts reading the image data to be converted (step S100). Here, the image data is described as RGB color image data, but it is not limited to color image data, and it is also possible to apply this in the same way for black and white image data as well.

After reading of the image data, the resolution conversion process is started (step S102). The resolution conversion process is a process that converts the resolution of the read image data to resolution (printing resolution) at which the color printer 200 is to print the image. When the print resolution is higher than the image data resolution, an interpolation operation is performed and new image data is generated to increase the resolution. Conversely, when the image data resolution is higher than the printing resolution, the resolution is decreased by culling the read image data at a fixed rate. With the resolution conversion process, by performing this kind of operation on the read image data, the image data resolution is converted to the printing resolution.

Once the image data resolution is converted to the printing resolution in this way, next, color conversion processing is performed (step S104). Color conversion processing is a process of converting RGB color image data expressed by a combination of R, G, and B tone values to image data expressed by combinations of tone values of each color used for printing. As described previously, the color printer 200 prints images using four colors of ink C, M, Y, and K. In light of this, with the color conversion process of this embodiment, the image data expressed by each color RGB undergoes the process of conversion to data expressed by the tone values of each color C, M, Y, and K.

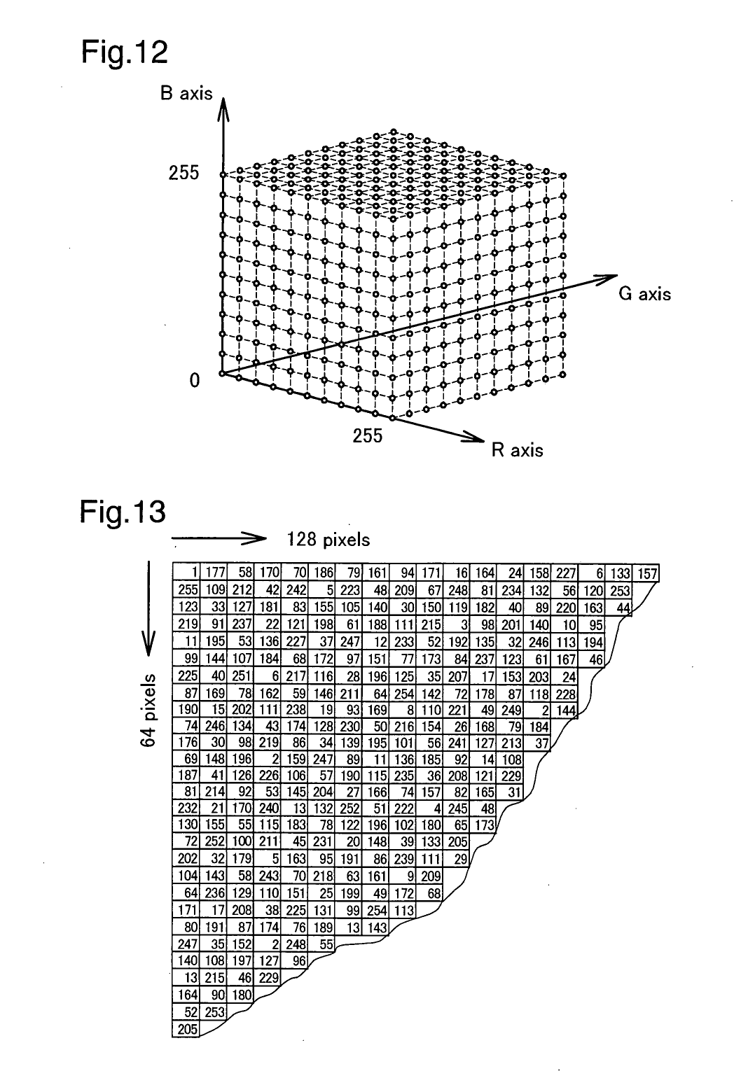

The color conversion process is able to be performed rapidly by referencing a color conversion table (LUT). FIG. 12 is an explanatory drawing that conceptually shows the LUT referenced for color conversion processing. The LUT can be thought of as a three dimensional number chart if thought of in the following way. First, as shown in FIG. 12, we think of a color space using three orthogonal axes of the R axis, the G axis, and the B axis. When this is done, all the RGB image data can definitely be displayed correlated to coordinate points within the color space. From this, if the R axis, the G axis, and the B axis are respectively subdivided and a large number of grid points are set within the color space, each of the grid points can be thought of as representing the RGB image data, and it is possible to correlate the tone values of each color C, M, Y, and K corresponding to each RGB image data to each grid point. The LUT can be thought of as a three dimensional number chart in which is correlated and stored the tone values of each color C, M, Y, and K to the grid points provided within the color pace in this way. If color conversion processing is performed based on the correlation of RGB color image data and tone data of each color C, M, YU, and K stored in this kind of LUT, it is possible to rapidly convert RGB color image data to tone data of each color C, M, Y, and K.

When tone data of each color C, M, Y, and K is obtained in this way, the computer 100 starts the tone number conversion process (step S106). The tone number conversion process is the following kind of process. The image data obtained by the color conversion process, if the data length is 1 byte, is tone data for which values can be taken from tone value 0 to tone value 255 for each pixel. In comparison to this, the printer displays images by forming dots, so for each pixel, it is only possible to have either state of “dots are formed” or “dots are not formed.” In light of this, instead of changing the tone value for each pixel, with this kind of printer, images are expressed by changing the density of dots formed within a specified area. The tone number conversion process is a process that, to generate dots at a suitable density according to the tone value of the tone data, decides the presence or absence of dot formation for each pixel.

As a method of generating dots at a suitable density according to the tone values, various methods are known such as the error diffusion method and the dither method, but with the Tone number conversion process of this embodiment, the method called the dither method is used. The dither method of this embodiment is a method that decides the presence or absence of dot formation for each pixel by comparing the threshold value set in the dither matrix and the tone value of the image data for each pixel. Following is a simple description of the principle of deciding on the presence or absence of dot formation using the dither method.

FIG. 13 is an explanatory drawing that conceptually shows an example of part of a dither matrix. The matrix shown in the drawing randomly stores threshold values selected thoroughly from a tone value range of 1 to 255 for a total of 8192 pixels, with 128 pixels in the horizontal direction (main scan direction) and 64 pixels in the vertical direction (Sub-scan direction). Here, selecting from a range of 1 to 255 for the tone value of the threshold value with this embodiment is because in addition to having the image data as 1 byte data that can take tone values from values 0 to 255, when the image data tone value and the threshold value are equal, it is decided that a dot is formed at that pixel.

Specifically, when dot formation is limited to pixels for which the image data tone value is greater than the threshold value (specifically, dots are not formed on pixels for which the tone value and threshold value are equal), dots are definitely not formed at pixels having threshold values of the same value as the largest tone value that the image data can have. To avoid this situation, the range that the threshold values can have is made to be a range that excludes the maximum tone value from the range that the image data can have. Conversely, when dots are also formed on pixels for which the image data tone value and the threshold value are equal, dots are always formed at pixels having a threshold value of the same value as the minimum tone value that the image data has. To avoid this situation, the range that the threshold values can have is made to be a range excluding the minimum tone value from the range that the image data can have. With this embodiment, the tone values that the image data can have is from 0 to 255, and since dots are formed at pixels for which the image data and the threshold value are equal, the range that the threshold values can have is set to 1 to 255. Note that the size of the dither matrix is not limited to the kind of size shown by example in FIG. 13, but can also be various sizes including a matrix for which the vertical and horizontal pixel count is the same.

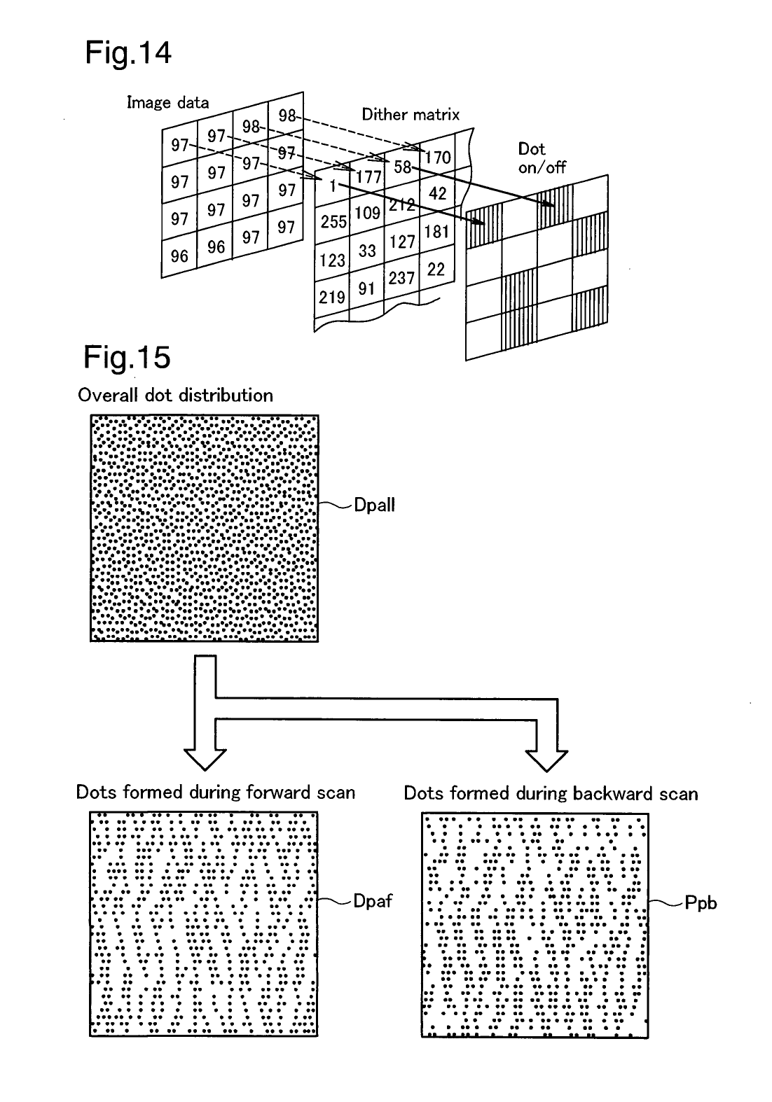

FIG. 14 is an explanatory drawing that conceptually shows the state of deciding the presence or absence of dot formation for each pixel while referring to the dither matrix. When deciding on the presence or absence of dot formation, first, a pixel for deciding about is selected, and the tone value of the image data for that pixel and the threshold value stored at the position corresponding in the dither matrix are compared. The fine dotted line arrow shown in FIG. 14 typically represents the comparison for each pixel of the tone value of the image data and the threshold value stored in the dither matrix. For example, for the pixel in the upper left corner of the image data, the threshold value of the image data is 97, and the threshold value of the dither matrix is 1, so it is decided that dots are formed at this pixel. The arrow shown by the solid line in FIG. 14 typically represents the state of it being decided that dots are formed in this pixel, and of the decision results being written to memory. Meanwhile, for the pixel that is adjacent at the right of this pixel, the tone value of the image data is 97, and the threshold value of the dither matrix is 177, and since the threshold value is larger, it is decided that dots are not formed at this pixel, With the dither method, by deciding whether or not to form dots for each pixel while referencing the dither matrix in this way, image data is converted to data representing the presence or absence of dot formation for each pixel. In this way, if using the dither method, it is possible to decide the presence or absence of dot formation for each pixel with a simple process of comparing the tone value of the image data and the threshold value set in the dither matrix, so it is possible to rapidly implement the tone number conversion process.

Also, when the image data tone value is determined, as is clear from the fact that whether or not dots are formed on each pixel is determined by the threshold value set in the dither matrix, with the dither method, it is possible to actively control the dot generating status by the threshold value set in the dither matrix. With the tone number conversion process of this embodiment, using this kind of feature of the dither method, by deciding on the presence or absence of dot formation for each pixel using the dither matrix having the special characteristics described later, even in cases when there is dot formation position misalignment between dots formed during forward scan and dots formed during backward scan when doing bidirectional printing, it is possible to suppress to a minimum the degradation of image quality due to this. The principle of being able to suppress to a minimum the image quality degradation and the characteristics provided with a dither matrix capable of this are described in detail later.

When the tone number conversion process ends and data representing the presence or absence of dot formation for each pixel is obtained from the tone data of each color C, M, Y, and K, this time, the interlace process starts (step S108). The interlace process is a process that realigns the sequence of transfer of image data converted to the expression format according to the presence or absence of dot formation to the color printer 200 while considering the sequence by which dots are actually formed on the printing paper. The computer 100, after realigning the image data by performing the interlace process, outputs the finally obtained data as control data to the color printer 200 (step S110).

The color printer 200 prints images by forming dots on the printing paper according to the control data supplied from the computer 100 in this way. Specifically, as described previously using FIG. 3, the main scan and the Sub-scan of the carriage 240 are performed by driving the carriage motor 230 and the paper feed motor 235, and the head 241 is driven based on the dot data to match these movements, and ink drops are sprayed. As a result, suitable color ink dots are formed at suitable positions and an image is printed.

The color printer 200 described above forms dots while moving the carriage 240 back and forth to print images, so if dots are formed not only during the forward scan of the carriage 240 but also during the backward scan, it is possible to rapidly print images. It makes sense that when performing this kind of bidirectional printing, when dot formation position misalignment occurs between dots formed during the forward scan of the carriage 240 and the dots formed during the backward scan, the image quality will be degraded. In light of this, to avoid this kind of situation, a normal color printer is made to be able to adjust with good precision the timing of forming dots for at least one of during forward scan or backward scan. Because of this, it is possible to match the position at which dots are formed during the forward scan and the position at which dots are formed during the backward scan, and it is possible to rapidly print images with high image quality without degradation of the image quality even when bidirectional printing is performed. However, on the other hand, because it is possible to adjust with good precision the timing of forming dots, a dedicated adjustment mechanism or adjustment program is necessary, and there is a tendency for the color printer to become more complex and larger.

To avoid the occurrence of this kind of problem, with the computer 100 of this embodiment, even when there is a slight displacement of the dot formation position during the forward scan and the backward scan, the presence or absence of dot formation is decided using a dither matrix that makes it possible to suppress to a minimum the effect on image quality. If the presence or absence of dot formation for each pixel is decided by referencing this kind of dither matrix, even if there is slight displacement of the dot formation positions between the forward scan and the backward scan, there is no significant effect on the image quality. Because of this, it is not necessary to adjust with high precision the dot formation position, and it is possible to use simple items for the mechanism and control contents for adjustment, so it is possible to avoid the color printer from becoming needlessly large and complex. Following, the principle that makes this possible is described, and after that, a simple description is given of one method for generating this kind of dither matrix.

### D. Principle of Suppressing Degradation of Image Quality Due to Dot Position Misalignment

The invention of this application was completed with the discovery of new findings regarding images formed using the dither matrix as the beginning. In light of this, first, the findings we newly discovered as the beginning of the invention of this application are explained.

FIG. 15 is an explanatory drawing showing the findings that became the beginning of the invention of this application. Overall dot distribution Dpall shows an expanded view of the state of dots being formed at a specified density for forming images of certain tone values. As shown in Overall dot distribution Dpall, to obtain the optimal image quality image, it is necessary to form dots in a state dispersed as thoroughly as possible.

To form dots in a thoroughly dispersed state in this way, it is known that it is possible to reference a dither matrix having so-called blue noise characteristics to decide the presence or absence of dot formation. Here, a dither matrix having blue noise characteristics means a matrix like the following. Specifically, it means a dither matrix for which while dots are formed irregularly, the spatial frequency component of the set threshold value has the largest component in a high frequency range for which one cycle is two pixels or less. Note that bright (high brightness level) images and the like can also be cases when dots are formed in regular patterns near a specific brightness level.

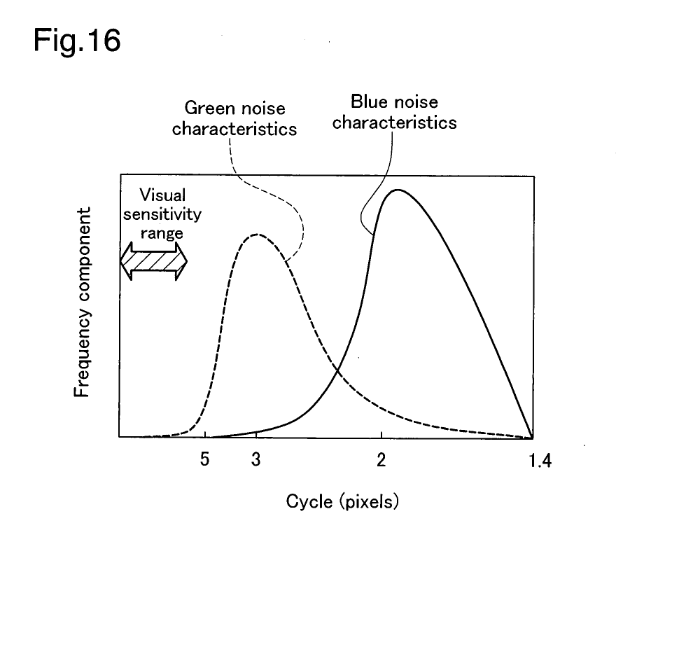

FIG. 16 is an explanatory drawing that conceptually shows an example of the spatial frequency characteristics of the threshold values set for each pixel of a dither matrix having blue noise characteristics (following, this may also be called a blue noise matrix). Note that with FIG. 16, in addition to the blue noise matrix spatial frequency characteristics, there is also a display regarding the spatial frequency characteristics of the threshold values set in a dither matrix having so called green noise characteristics (hereafter, this is also called a green noise matrix). The green noise matrix spatial frequency characteristics will be described later, but first, the blue noise matrix spatial frequency characteristics are described.

In FIG. 16, due to circumstances of display, instead of using spatial frequency for the horizontal axis, cycles are used. It goes without saying that the shorter the cycle, the higher the spatial frequency. Also, the vertical axis of FIG. 16 shows the spatial frequency component for each of the cycles. Note that the frequency components shown in the drawing indicate a state of being smoothed so that the changes are smooth to a certain degree.

The spatial frequency component of the threshold values set for the blue noise matrix is shown by example using the solid line in the drawing. As shown in the drawing, the blue noise matrix spatial frequency characteristics are characteristics having the maximum frequency component in the high frequency range for which one cycle length is two pixels or less. The threshold values of the blue noise matrix are set to have this kind of spatial frequency characteristics, so if the presence or absence of dot formation is decided based on a matrix having this kind of characteristics, then dots are formed in a state separated from each other.

From the kinds of reasons described above, if the presence or absence of dot formation for each pixel is decided while referencing a dither matrix having blue noise characteristics, as shown in the Overall dot distribution Dpall of FIG. 15, it is possible to obtain an image with thoroughly dispersed dots. Conversely, because dots are generated dispersed thoroughly as shown in the Overall dot distribution Dpall of FIG. 15, threshold values adjusted so as to have blue noise characteristics are set in the dither matrix.

Note that here, the spatial frequency characteristics of the threshold values set in the green noise matrix shown in FIG. 16 are described. The dotted line curve shown in FIG. 16 shows an example of green noise matrix spatial frequency characteristics. As shown in the drawing, green noise matrix spatial frequency characteristics are characteristics having the largest frequency component in the medium frequency range for which the length of one cycle is from two pixels to ten or more pixels. The green noise matrix threshold values are set so as to have this kind of spatial frequency characteristics, so when the presence or absence of dot formation for each pixel is decided while referencing a dither matrix having green noise characteristics, while dots are formed adjacent in several dot units, overall, the dot group is formed in a dispersed state. As with a so-called laser printer or the like, with a printer for which stable formation of fine dots of approximately one pixel is difficult, by deciding the presence or absence of dot formation while referencing this kind of green noise matrix, it is possible to suppress the occurrence of isolated dots. As a result, it becomes possible to rapidly output images with stable image quality. Conversely, threshold values adjusted to have green noise characteristics are set in the dither matrix referenced when deciding the presence or absence of dot formation with a laser printer or the like.

As described above, with an inkjet printer like the color printer 200, a dither matrix having blue noise characteristics is used, and therefore, as shown in the Overall dot distribution Dpall of FIG. 15, the obtained image is an image with thoroughly dispersed dots. However, when this image is viewed with the dots formed during forward scan of the head separated from the dots formed during the backward scan, we found that the images made only by dots formed during the forward scan (forward scan images) and the images made only by dots formed during the backward scan (backward scan images) do not necessarily have the dots thoroughly dispersed. Dots formed during forward scan Dpf is an image obtained by extracting only the dots formed during the forward scan from the image shown in the Overall dot distribution Dpall. Also, Dots formed during backward scan Dpb is an image obtained by extracting only the dots formed during the backward scan from the image shown in the Overall dot distribution Dpall.

As shown in the drawing, if the dots formed by both the back and forth movements are matched, as shown in the Overall dot distribution Dpall, regardless of the fact that the dots are formed thoroughly, the image of only the dots formed during the forward scan shown in the dots formed during forward scan Dpf or the image of only the dots formed during the backward scan shown in the dots formed during backward scan Dpb are both generated in a state with the dots unbalanced.

In this way, though it is unexpected that there would be a big difference in tendency, if we think in the following way, it seems that this is a phenomenon that occurs half by necessity. Specifically, as described previously, the dot distribution status depends on the setting of the threshold values of the dither matrix, and the dither matrix threshold values are set with special generation of the distribution of the threshold values to have blue noise characteristics so that the dots are dispersed well. Here, among the dither matrix threshold values, threshold values of pixels for which dots are formed during the forward scan or threshold values of pixels for which dots are formed during the backward scan are taken, and with no consideration such has having the distribution of the respective threshold values having blue noise characteristics, the fact that the distribution of these threshold values, in contrast to the blue noise characteristics, have characteristics having a large frequency component in the long frequency range, seems half necessary (see FIG. 16). Also, for a dither matrix having green noise characteristics as well, when we consider that this is a matrix specially set for the threshold value distribution to have green noise characteristics, the threshold values of the pixels for which dots are formed during the forward scan or the backward scan are considered to have a large frequency component on a longer cycle side than the cycle for which the green noise matrix has a large frequency component (see FIG. 16). In the end, when the threshold values of pixels for which dots are formed during the forward scan or the threshold values of pixels for which dots are formed during the backward scan are taken from the dither matrix having blue noise characteristics, the distribution of those threshold values have large frequency components in the Visually sensitive range. Because of this, for example, even when images have dots thoroughly dispersed, when only dots formed during the forward scan or only dots formed during the backward scan are removed, the obtained images respectively are considered to be images for which the dots have unbalance occur such as shown in the dots formed during forward scan Dpf and the dots formed during backward scan Dpb. Specifically, the phenomenon shown in FIG. 15 is not a special phenomenon that occurs with a specific dither matrix, but rather can be thought of as the same phenomenon that occurs with most dither matrixes.

Considering the kind of new findings noted above and the considerations for these findings, studies were done for other dither matrixes as well. With the study, to quantitatively evaluate the results, an index called the granularity index was used. In light of this, before describing the study results, we will give a brief description of the granularity index.

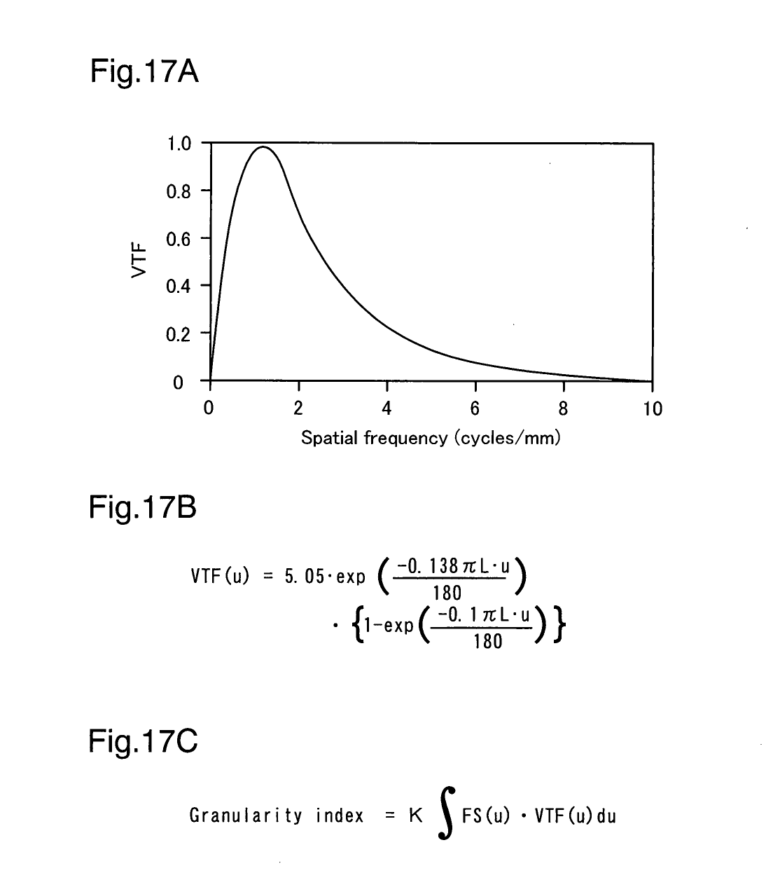

FIGS. 17A to 17C are explanatory drawings that conceptually shows the sensitivity characteristics VTF (Visual Transfer Function) to the visual spatial frequency that humans have. As shown in the drawing, human vision has a spatial frequency showing a high sensitivity, and there is a characteristic of the sensitivity decreasing gradually as the spatial frequency increases. It is also known that there is a characteristic of the vision sensitivity decreasing also in ranges for which the spatial frequency is extremely low. An example of this kind of human vision sensitivity characteristic is shown in FIG. 17A. Various experimental formulae have been proposed as an experimental formula for giving this kind of sensitivity characteristic, but a representative experimental formula is shown in FIG. 17B. Note that the variable L in FIG. 17B represents the observation distance, and the variable u represents the spatial frequency.

Based on this kind of visual sensitivity characteristic VTF, it is possible to think of a granularity index (specifically, an index representing how easy it is for a dot to stand out). Now, we will assume that a certain image has been Fourier transformed to obtain a power spectrum. If that power spectrum happens to contain a large frequency component, that doesn't necessarily mean that that image will immediately be an image for which the dots stand out. This is because as described previously using FIG. 17A, if that frequency is in the low range of human visual sensitivity, for example even if it has a large frequency component, the dots do not stand out that much. Conversely, with frequencies in the high range of human visual sensitivity, for example even when there are only relatively low frequency components, for the entity doing the viewing, there are cases when the dots are sensed to stand out. From this fact, the image is Fourier transformed to obtain a power spectrum FS, the obtained power spectrum FS is weighted to correlate to the human visual sensitivity characteristic VTF, and if integration is done with each spatial frequency, then an index indicating whether or not a human senses the dots as standing out or not is obtained. The granularity index is an index obtained in this way, and can be calculated by the calculation formula shown in FIG. 17C. Note that the coefficient K in FIG. 17C is a coefficient for matching the obtained value with the human visual sense.

To confirm that the phenomenon described previously using FIG. 15 is not a special phenomenon that occurs with a specific dither matrix, but rather occurs also with most dither matrixes, the following kind of study was performed on various dither matrixes having blue noise characteristics. First, from among the dots formed by bidirectional printing, images made only by dots formed during the forward scan such as shown in the dots formed during forward scan Dpf (forward scan images) are obtained. Next, the granularity index of the obtained images is calculated. This kind of operation was performed for various dither matrixes while changing the image tone values.

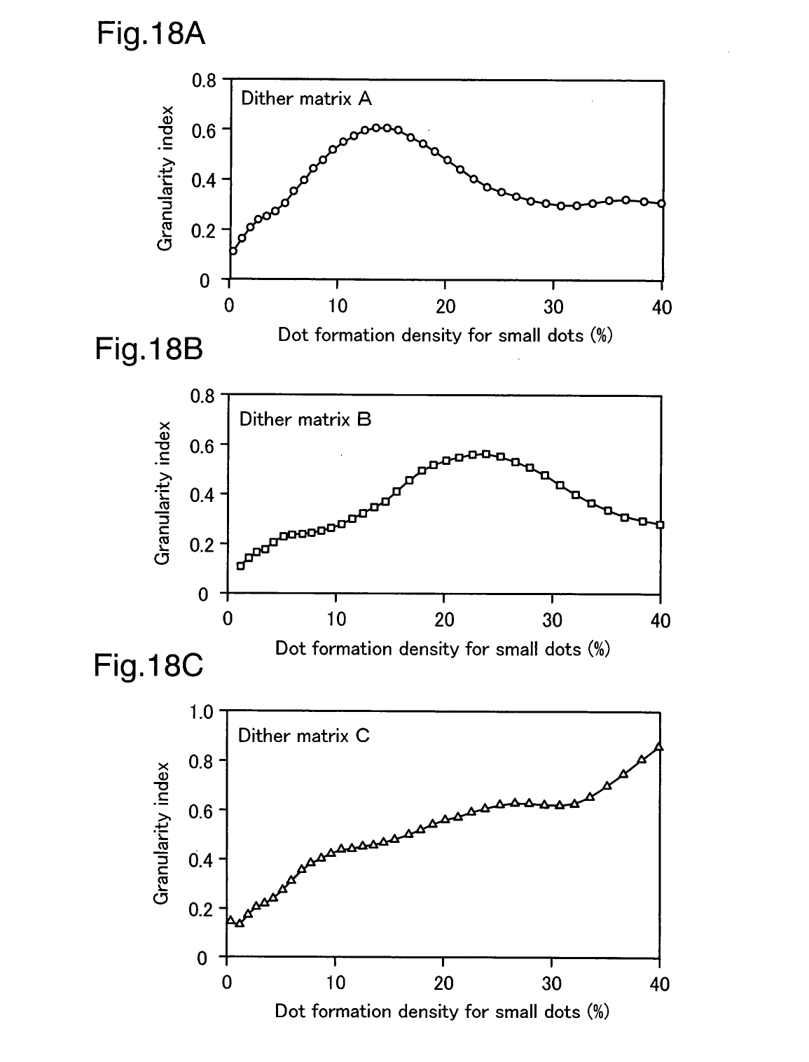

FIGS. 18A to 18C are explanatory drawings showing the results of studying the granularity index of forward scan images for various dither matrixes having blue noise characteristics. Shown in FIGS. 18A to 18C are only the results obtained for three dither matrixes with different resolutions. The dither matrix A shown in FIG. 18A is a dither matrix for printing at a main scan direction resolution of 1440 dpi and Sub-scan direction resolution of 720 dpi, and the dither matrix B shown in FIG. 18B is a dither matrix used for printing at a resolution of 1440 dpi for both the main scan direction and the Sub-scan direction. Also, the dither matrix C shown in FIG. 18C is a dither matrix for printing in the main scan direction at a resolution of 720 dpi and in the Sub-scan direction at a resolution of 1440 dpi. Note that in FIGS. 18A to 18C, the horizontal axis is displayed using the small dot formation density, and the areas for which the displayed small dot formation density is 40% or less correlate to areas up to before the intermediate gradation area from the highlight area for which it is considered that the dots stand out relatively easily.

Regardless of the fact that the three forward scan images shown in FIGS. 18A to 18C are generated from individually created dither matrixes for printing respectively at different resolutions, each has an area for which the granularity index is degraded (specifically, an area in which the dots stand out easily). In this kind of area, the forward scan image can be thought of as the dots generating imbalance as shown in the dots formed during forward scan Dpf of FIG. 15. In the end, all of the three dither matrixes shown in FIGS. 18A to 18C have blue noise characteristics, and therefore, regardless of the fact that the images formed using bidirectional printing have dots formed without imbalance, in at least part of the gradation area, the forward scan image or the backward scan image has dot imbalance occur. From this, the phenomenon described previously using FIG. 15 can be thought of not as a special phenomenon that occurs with a specific dither matrix but rather as a general phenomenon that occurs with most dither matrixes. Then, when we consider the occurrence of dot imbalance with either forward scan images or backward scan images in this way, this can be thought of as possibly having an effect on the image quality degradation due to dot position misalignment during bidirectional printing. In light of this, we tried studying to see whether or not any kind of correlation can be seen between the granularity index of images formed with an intentional displacement in the dot formation position during bidirectional printing (position misalignment image) and the granularity index of forward scan images.

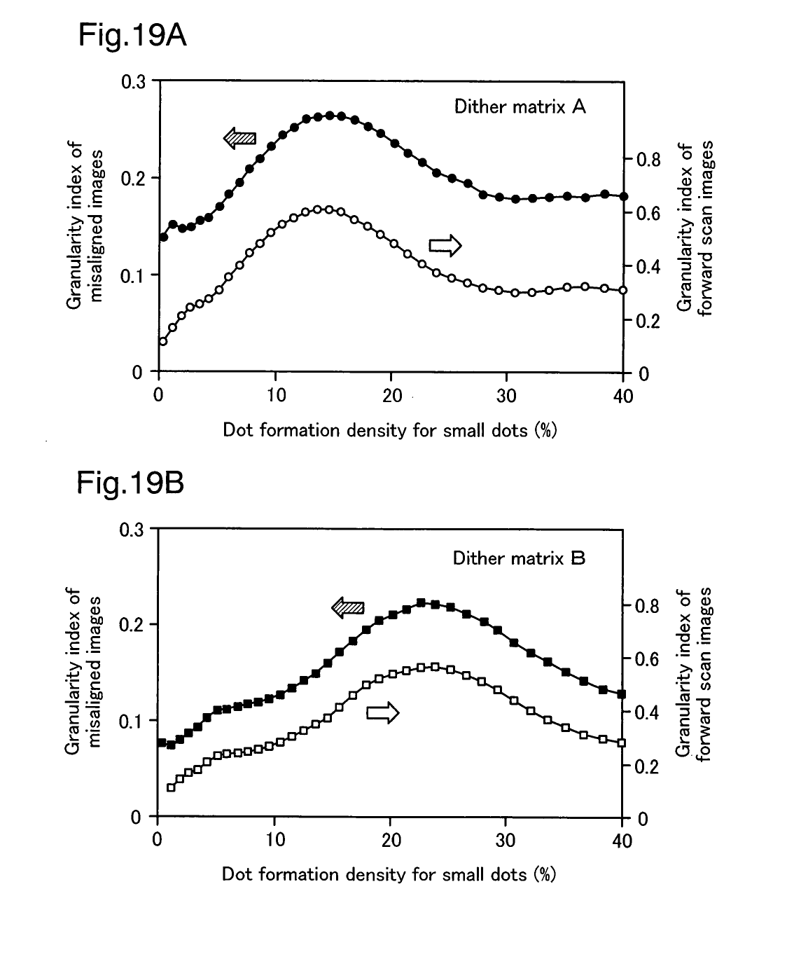

FIGS. 19A and 19B are explanatory drawings showing the results of studying the correlation coefficient between the position misalignment image granularity index and the forward scan image granularity index. FIG. 19A shows the results of a study on the dither matrix A shown in FIG. 18A, and in the drawing, the black circles represent the position misalignment image granularity index and the white circles in the drawing represent the granularity index for the forward scan image. Also, FIG. 19B shows the results of a study on the dither matrix B shown in FIG. 18B, and the black squares represent the position misalignment image granularity index while the white squares represent the forward image granularity index. As is clear from FIGS. 19A and 19B, for any of the dither matrixes, a surprisingly strong correlation is seen between the position misalignment image granularity index and the forward image granularity index. From this fact, for the phenomenon of the image quality being degraded by the dot position misalignment during bidirectional printing, the fact that the bidirectional image dot imbalance becomes marked due to displacement of the relative position between the forward scan images and the backward scan images can be considered to be one significant factor. Conversely, if the dot imbalance between the forward scan images and the backward scan images is reduced, for example even when dot position misalignment occurs during bidirectional printing, it is thought that it is possible to suppress image quality degradation.

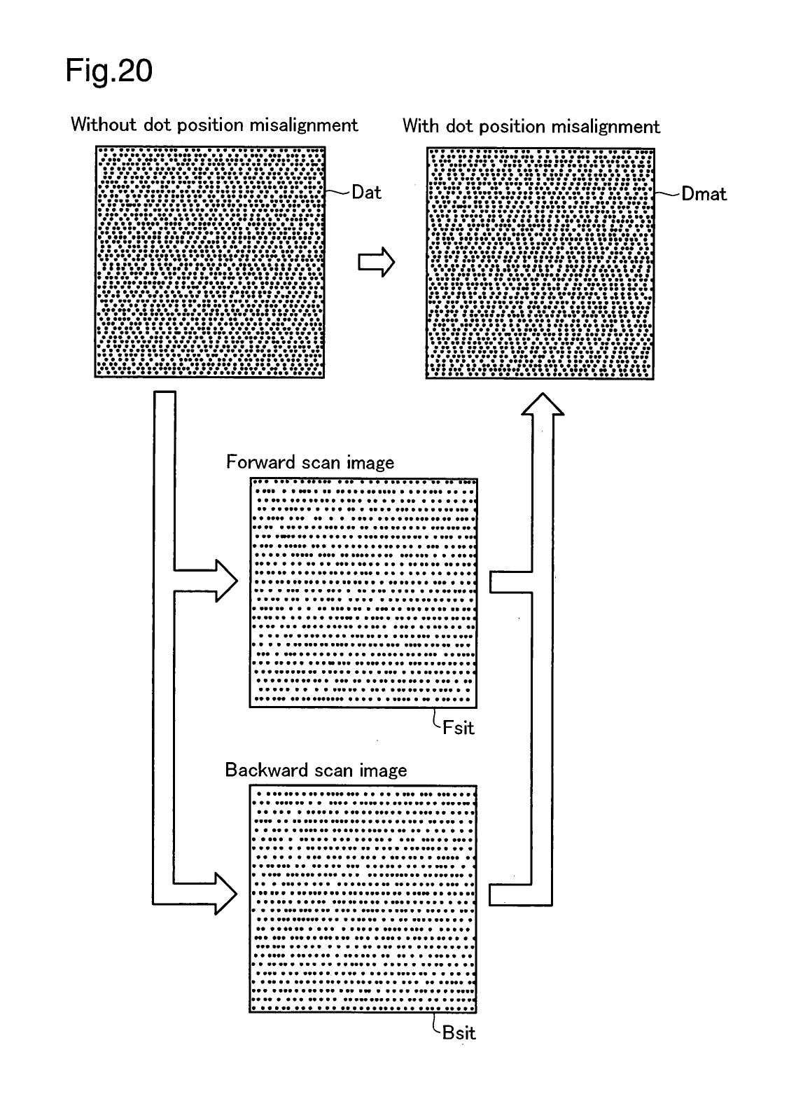

FIG. 20 is an explanatory drawing showing that it is possible to suppress the image quality degradation when dot position misalignment occurs during bidirectional printing if the dot imbalance is reduced for images during forward scan and images during backward scan. Dot pattern Dat and dot pattern Dmat show a comparison of an image for which bidirectional printing was performed in a state without dot position misalignment and an image printed in a state with intentional displacement by a specified volume of the dot formation position. Also, shown respectively in FIG. 20, Forward scan image Fsit and Backward scan image Bsit are images obtained by breaking down into an image made only by dots formed during the forward scan of the head (forward scan image) and an image made only by dots formed during the backward scan (backward scan image).

As shown in the forward scan image Fsit and the backward scan image Bsit, the forward scan images and the backward scan images are both images for which the dots are dispersed thoroughly. Also, as shown in the forward scan image Fsit, in the state with no dot position misalignment, images obtained by synthesizing the forward scan images and backward scan images (specifically, images obtained with bidirectional printing) are also images for which the dots are dispersed thoroughly. In this way, not just images obtained by performing bidirectional printing, but also when broken down into forward scan images and backward images, images that have the dots dispersed thoroughly with the respective images can be obtained by deciding the presence or absence of dot formation while referencing a dither matrix having the kind of characteristics described later in the tone number conversion process of FIG. 11. Then, the backward scan image Bsit correlates to an image for which this kind of forward scan image and backward scan image are overlapped in a state displaced by a specified amount.

If the image without position misalignment (left side image) shown in the forward scan image Fsit and the image with position misalignment (right side image) are compared, by the dot position being displaced, the right side image has its dots stand out slightly more easily than the left side image with no displacement, but we can understand that this is not at a level that greatly degrades the image quality. This is thought to show that even when broken down into forward scan images and backward scan images, if dots are generated so that the dots are dispersed thoroughly, for example even when dot position misalignment occurs during bidirectional printing, it is possible to greatly suppress degradation of image quality due to this.

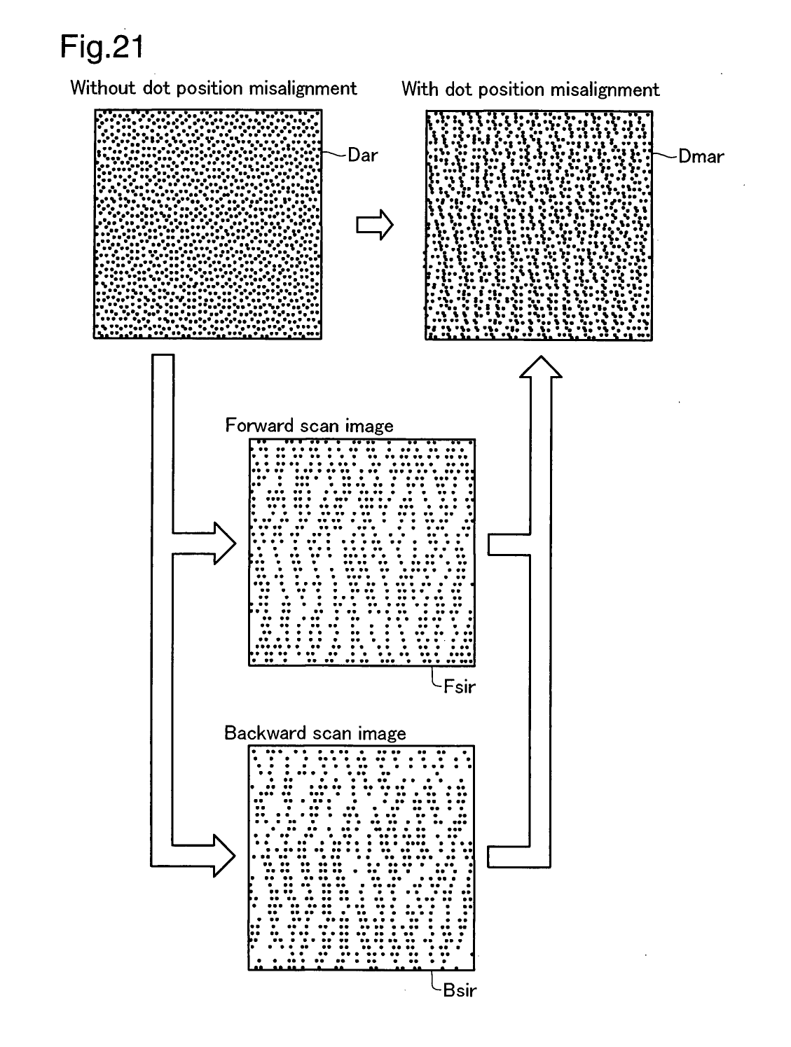

As a reference, with the image formed using a typical dither matrix, we checked to what degree image quality degraded when dot position misalignment occurred by the same amount as the case shown in FIG. 20. FIG. 21 is an explanatory drawing showing degradation of the image quality due to the presence or absence of dot position misalignment with the image formed by a typical dither matrix. The image without position misalignment (left side image) shown in Dot pattern Dar is an image for which the forward scan image and backward scan image shown in FIG. 15 are overlapped without any position misalignment. Also, the image with position misalignment shown in Dot pattern Dar is an image for which the forward scan image and the backward scan image are overlapped in a state with the position displaced by the same amount as the case shown in FIG. 20. Note that in the forward scan image Fsir and the backward scan image Bsir, the respective forward scan images and backward scan images are shown.

As is clear from FIG. 21, when dots are generated with imbalance with the forward scan image and the backward scan image, it is possible to confirm that when the dot formation positions are displaced during bidirectional printing, there is great degradation of the image quality when the image quality is greatly degraded [sic]. Also, when FIG. 20 and FIG. 21 are compared, by thoroughly dispersing the dots with the forward scan image and the backward scan image, it is possible to understand that the image quality degradation due to dot position misalignment can be dramatically improved.

With the color printer 200 of this embodiment, based on this kind of principle, it is possible to suppress to a minimum the image quality degradation due to dot position misalignment during bidirectional printing. Because of this, during bidirectional printing, even when the formation positions of the dots formed during forward scan and the dots formed during backward scan are not matched with high precision, there is no degradation of image quality. As a result, there is no need for a mechanism or control program for adjusting with good precision the dot position misalignment, so it is possible to use a simple constitution for the printer. Furthermore, it is possible to reduce the precision required for the mechanism for moving the head back and forth as well, and this point also makes it possible to simplify the printer constitution.

### E. Dither Matrix Generating Method

Next, a simple description is given of an example of a method of generating a dither matrix to be referenced by the tone number conversion process of this embodiment. Specifically, with the tone number conversion process of this embodiment, for dots formed during the forward scan, for dots formed during the backward scan, and furthermore, for combinations of these dots, dots are generated in a thoroughly dispersed state, so gradation conversion processing is performed while referencing a dither matrix having the following two kinds of characteristics.

“First Characteristic”: The dither matrix pixel positions can be classified into first pixel position groups and second pixel position groups. Here, the first pixel position and the second pixel position mean pixel positions having a mutual relationship such that when dots are formed by either the forward scan or the backward scan, the other has dots formed by the other.

“Second Characteristic”: The dither matrix and a matrix for which the threshold values set for the first pixel position are removed from that dither matrix (first pixel position matrix), and a matrix for which the threshold values set for the second pixel positions are removed (second pixel position matrix) all have either blue noise characteristics or green noise characteristics. Here, a “dither matrix having blue noise characteristics” means the following kind of matrix. Specifically, it means a dither matrix for which dots are generated irregularly and the spatial frequency component of the set threshold values have the largest component in the medium frequency range for which one cycle is from two pixels to ten or more pixels. Also, a “dither matrix having green noise characteristics” means a dither matrix for which dots are formed irregularly and the spatial frequency component of the set threshold values have the largest component in the medium frequency range for which one cycle has from two pixels to ten or more pixels. Note that if these dither matrixes are near a specific brightness, it is also acceptable if there are dots formed in a regular pattern.

As described previously, dither matrixes having these kind of characteristics can definitely not be generated by coincidence, so a brief description is given of an example of a method for generating this kind of dither matrix.

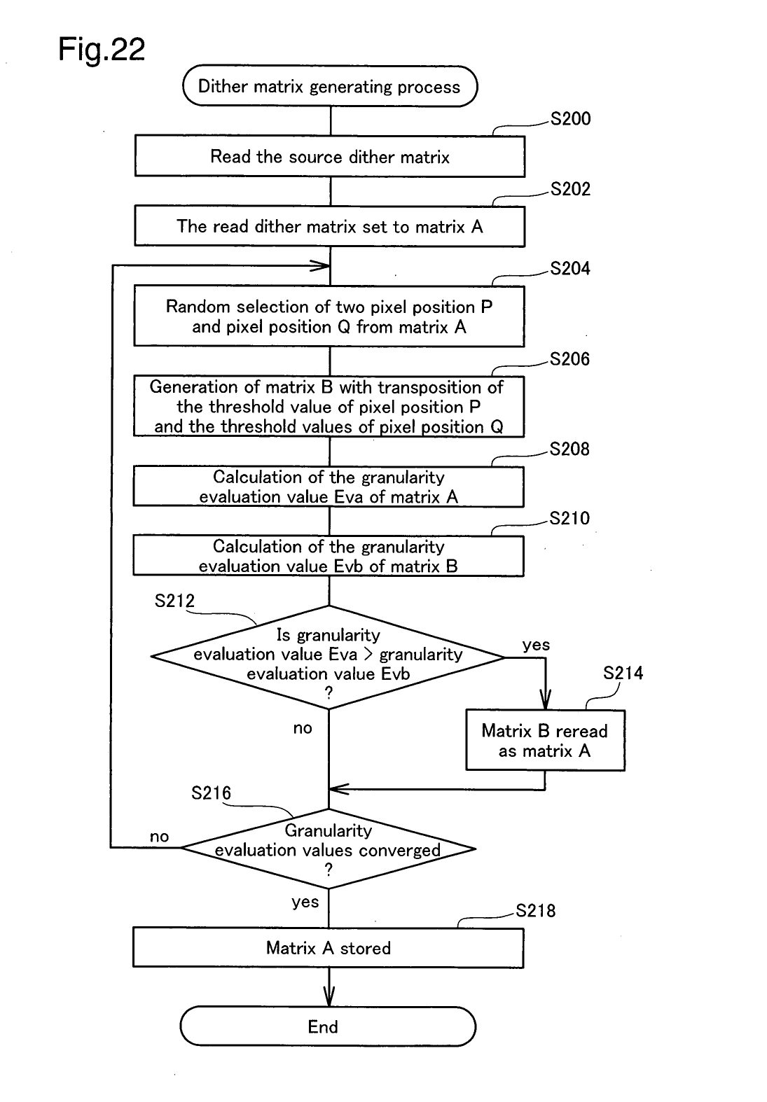

FIG. 22 is a flow chart showing the flow of the process of generating dither matrixes referenced with the tone number conversion process of this embodiment. Note that here, with an existing dither matrix having blue noise characteristics as a source, so that the “first characteristics” and “second characteristics” described above can be obtained, described is a method to which correction is added. It makes sense that rather than correcting the matrix that is the source, that it is also possible to generate first from a dither matrix having the “first characteristics” and “second characteristics.” Also, here, described is a case when a matrix having blue noise characteristics is the source, but it is also possible to obtain a dither matrix having the characteristics noted above by working in about the same manner when using a dither matrix having green noise characteristics as the source as well.

When the dither matrix generating process starts, first, the dither matrix that is the source is read (step S200). This matrix overall has blue noise characteristics, but the first pixel position matrix (the matrix for which the threshold values set at the first pixel position are removed from the dither matrix) and the second pixel position matrix (the matrix for which the threshold values set at the second pixel position are removed from the dither matrix) are both matrixes that do not have blue noise characteristics. Note that as described previously, the first pixel position and the second pixel position mean pixel positions in a mutual relationship for which when dots are formed either during forward scan or backward scan, the other has dots formed by the other.

Next, the read matrix is set as matrix A (step S202). Then, from the dither matrix A, two pixel positions (pixel position P and pixel position Q) are randomly selected (step S204), the threshold value set at the selected pixel position P and the threshold value set at the selected pixel position Q are transposed, and the obtained matrix is used as matrix B (step S206).

Next, the granularity evaluation value Eva for the matrix A is calculated (step S208). Here, the granularity evaluation value means an evaluation value obtained as follows. First, using the dither method on 256 images of tone values 0 to 255, 256 images are obtained expressed by the presence or absence of dot formation. Next, each image is broken down into forward scan images and backward scan images. As a result, for each of the tone values from 0 to 255, obtained are the forward scan image, the backward scan image, and an image for which these are overlapped (total image). For the 768 (=256×3) images obtained in this way, after calculation of the granularity index described previously using FIG. 17, the value obtained by finding the average value of these is used as the granularity evaluation value. Note that when calculating the granularity evaluation value, rather than simply using an arithmetic mean of the 768 granularity indices, it is also possible to take a weighted average respectively of the forward scan image, the backward scan image, and the total image. Alternatively, for a specific tone value (e.g. a low tone range for which it is said that dots stand out relatively easily), it is also possible to apply a large weighting coefficient and take the average. At step S208 of FIG. 22, for the matrix A, this kind of granularity evaluation value is found, and the obtained value is used as the granularity evaluation value Eva.

When the granularity evaluation value Eva is obtained for the matrix A, the granularity evaluation value Evb is calculated in the same manner for the matrix B as well (step S210). Next, the granularity evaluation value Eva for the matrix A and the granularity evaluation value Evb for the matrix B are compared (step S212). Then, when it is determined that the granularity evaluation value Eva is bigger (step S212: yes), the matrix B for which the threshold values set in the two pixel positions are transposed is through to have more desirable characteristics than the matrix A which is the source. In light of this, in this case, the matrix B is reread as matrix A (step S214). Meanwhile, when it is decided that the granularity evaluation value Evb of the matrix B is larger than the granularity evaluation value Eva of the matrix A (step S212: no), then matrix is not reread.

In this way, only in the case when it is determined that the granularity evaluation value Eva of the matrix A is larger than the granularity evaluation value Evb of the matrix B, when the operation of rereading the matrix B as the matrix A, a determination is made of whether or not the granularity evaluation values are converged (step S216). Specifically, the dither matrix set as the source has the dots formed during the forward scan and the dots formed during the backward scan generated with imbalance, so immediately after starting the kind of operation noted above, a large value is taken for the granularity evaluation value. However, by transposing the threshold values set in the two pixel position locations, when a smaller granularity evaluation value is obtained, if the matrix for which the threshold value is transposed is used, and the operation described above is further repeated for this matrix, the obtained granularity evaluation value becomes smaller, and it is thought that over time it becomes stable at a certain value. At step S216, a determination is made of whether or not the granularity evaluation value has stabilized, or said another way, whether or not it can be thought of as having reached bottom. For whether or not the granularity evaluation values have converged, for example, when the granularity evaluation value Evb of the matrix B is smaller than the granularity evaluation value Eva of the matrix A, the decrease volume of the granularity evaluation value is obtained, and if this decrease volume is a fixed value or less that is stable across a plurality of operations, it can be determined that the granularity evaluation values have converged.

Then, when it is determined that the granularity evaluation values have not converged (step S216: no), the process backwards to step S204, and after selecting two new pixel positions, the subsequent series of operations is repeated. While repeating this kind of operation, over time, the granularity evaluation values converge, and when it is determined that the granularity evaluation values have converged (step S216: yes), the matrix A at that time becomes a dither matrix having the previously described “first characteristics” and “second characteristics.” In light of this, this matrix A is stored (step S218), and the dither matrix generating process shown in FIG. 22 ends.

If tone number conversion processing is performed while referencing a dither matrix obtained in this way, and a decision is made on the presence or absence of dot formation for each pixel, it goes without saying for the overall image, as well as for the forward scan images and the backward scan images, that it is possible to obtain images for which the dots are dispersed well. Because of this, for example even when there is slight displacement of the dot formation positions during bidirectional printing, it is possible to suppress to a minimum the effect on the image quality by this.

Note that with this embodiment, the granularity evaluation value Eva used to evaluate the dither matrix is calculated based on the granularity index that is the subjective evaluation value that uses the visual sensitivity characteristic VTF, but it is also possible to calculate based on the RMS granularity that is the standard deviation of the density distribution, for example.

The granularity index is a well known method and is an evaluation index used widely from the past. However, calculation of the granularity index, as described previously, means obtaining the power spectrum FS by doing Fourier transformation of an image, and it is necessary to add a weighting to the obtained power spectrum FS that correlates to the human visual sensitivity characteristics VTF, so there is the problem of the calculation volume becoming very large. Meanwhile, the RMS granularity is an objective measure representing variance of dot denseness, and this can be calculated simply just by the smoothing process using a smoothing filter set according to the resolution and calculation of the standard deviation of the dot formation density, so it is perfect for optimization processing which has many repeated calculations. In addition, use of the RMS granularity has the advantage of flexible processing being possible considering the human visual sensitivity and visual environment according to the design of the smoothing filter in comparison to the fixed process that uses the human visual sensitivity characteristics VTF.

### F. Variation Examples

Above, a number of embodiments of the invention were described, but the invention is in no way limited to these kinds of embodiments, and it is possible to embody various aspects in a scope that does not stray from the key points. For example, the following kinds of variation examples are possible.

With the embodiments described above, halftone processing was performed using a dither matrix, but it is also possible to use this invention in cases when halftone processing is performed using error diffusion, for example. Using error diffusion can be realized by having error diffusion processing performed for each of a plurality of pixel position groups, for example.

In specific terms, it is possible to perform processing that diffuses a separate error to each of the plurality of pixel groups in addition to the normal error diffusion, for example, or to increase the weighting of the error diffused to the pixels belonging to the plurality of pixel groups. This is because even when configured in this way, with the original characteristics of the error diffusion method, for each tone value, any of the dot patterns formed on the print pixels belonging to each of the plurality of pixel groups has specified characteristics.

Note that with the dither method of the embodiments noted above, by comparing for each pixel the threshold values set in the dither matrix and the tone values of the image data, the presence or absence of dot formation is decided for each pixel, but it is also possible to decide the presence or absence of dot formation by comparing the threshold values and the sum of the tone values with a fixed value, for example. Furthermore, it is also possible to decide the presence or absence of dot formation according to the data generated in advance based on threshold value as and on the tone values without directly using the threshold values. The dither method of this invention generally can be a method that decides the presence or absence of dot formation according to the tone value of each pixel and the threshold value set for the pixel position corresponding to the dither matrix.

Finally, the present application claims the priority based on Japanese Patent Application No. 2006-204143 filed on Jul. 27, 2006, which are herein incorporated by reference.

What is claimed is:

1. A printing method of performing printing on a print medium, comprising:
generating dot data representing a status of dot formation on each of print pixels of a print image to be formed on the print medium, by performing a halftone process on image data representing a input tone value of each of pixels constituting an original image;
generating the print image by combining forward pass dots with backward pass dots in a common printing area in such a manner that each main scan line includes both the forward pass dots and the backward pass dots, the forward pass dots being formed on a plurality of pixels of a first pixel group in a forward pass of main scan of a print head, the backward pass dots being formed on a plurality of pixels of a second pixel group in a backward pass of main scan of the print head, wherein
the generating dot data includes setting a halftone process condition for reducing a deterioration of image quality due to a positional misalignment between the forward pass dots formed in the first pixel group and the backward pass dots formed in the second pixel group.

2. The method according to claim 1, wherein
the generating the print image includes forming a greater consecutive number of either the forward pass dots or the backward pass dots in a sub-scanning direction than a consecutive number of the corresponding dots in a main scanning direction.

3. The method according to claim 1, wherein
the generating the print image forming each sub-scan line by only either one of the forward pass dots and the backward pass dots.

4. The method according to claim 1, wherein
the generating the print image includes performing sub-scan feed by a fixed sub-scan feed volume of WP×(N+½), where WP represents a length of each print pixel in a sub-scanning direction and N denotes a non-negative integral value.

5. The method according to claim 1, wherein
both the forward pass dots formed in the first pixel group and the backward pass dots formed in the second pixel group have either one of blue noise characteristics or green noise characteristics.

6. A printing apparatus for printing on a print medium, comprising:
a dot data generator that generates dot data representing a status of dot formation on each of print pixels of a print image to be formed on the print medium, by performing a halftone process on image data representing a input tone value of each of pixels constituting an original image; and
a printing unit that has a print head and generates the print image by combining forward pass dots with backward pass dots in a common printing area in such a manner that each main scan line includes both the forward pass dots and the backward pass dots, the forward pass dots being formed on a plurality of pixels of a first pixel group in a forward pass of main scan of a print head, the backward pass dots being formed on a plurality of pixels of a second pixel group in a backward pass of main scan of the print head, wherein
the dot data generator is configured such that a halftone process condition is set for reducing a deterioration of image quality due to a positional misalignment between the forward pass dots formed in the first pixel group and the backward pass dots formed in the second pixel group.
